(19) United States
(12) Patent Application Publication
(10) Pub. No.: US 2023/0336232 A1
(43) Pub. Date: Oct. 19, 2023

(54) METHOD AND APPARATUS FOR SUPPORTING BEAM SWITCHING

(71) Applicant: ELECTRONICS AND TELECOMMUNICATIONS RESEARCH INSTITUTE, Daejeon (KR)

(72) Inventors: Sung Hyun MOON, Daejeon (KR); Cheul Soon KIM, Daejeon (KR); Jung Hoon LEE, Daejeon (KR)

(73) Assignee: ELECTRONICS AND TELECOMMUNICATIONS RESEARCH INSTITUTE, Daejeon (KR)

(21) Appl. No.: 18/296,028

(22) Filed: Apr. 5, 2023

(30) Foreign Application Priority Data
Apr. 14, 2022 (KR) 10-2022-0046262
Aug. 11, 2022 (KR) 10-2022-0100650
Oct. 13, 2022 (KR) 10-2022-0131313
Jan. 11, 2023 (KR) 10-2023-0004307
Mar. 31, 2023 (KR) 10-2023-0042392

(51) Int. Cl. H04B 7/06; H04W 72/23

(52) U.S. Cl. CPC H04B 7/0695; H04W 72/23

(57) ABSTRACT

A method of a terminal may comprise: receiving, from a base station, first unified transmission configuration indicator (TCI) information including a first TCI and a second TCI; receiving, from the base station, first downlink control information (DCI) including first scheduling information of a first physical downlink shared channel (PDSCH) and information indicating at least one TCI among the first TCI and the second TCI belonging to the first unified TCI information; and performing a first reception operation for the first PDSCH based on the at least one TCI and the first scheduling information.

### CROSS-REFERENCE TO RELATED APPLICATIONS

This application claims priority to Korean Patent Applications No. 10-2022-0046262, filed on Apr. 14, 2022, No. 10-2022-0100650, filed on Aug. 11, 2022, No. 10-2022-0131313, filed on Oct. 13, 2022, No. 10-2023-0004307, filed on Jan. 11, 2023, and No. 10-2023-0042392, filed on Mar. 31, 2023, with the Korean Intellectual Property Office (KIPO), the entire contents of which are hereby incorporated by reference.

### BACKGROUND

### 1. Technical Field

Exemplary embodiments of the present disclosure relate to a technique for transmitting and receiving signals in a mobile communication system, and more specifically, to a technique for supporting fast beam switching of a terminal in high frequency band communication.

### 2. Related Art

In the future industry, the wireless communication infrastructure is becoming increasingly important, and accordingly, a next-generation communication system (e.g., new radio (NR) communication system, 6G communication system, and/or the like) that provides more advanced performance is attracting attention. The next-generation communication system should support not only a conventional mobile communication frequency band, but also a millimeter wave band of 6 GHz or above, a terahertz band, and the like, and should support more diverse communication scenarios than the conventional communication system (e.g., long-term evolution (LTE) communication system).

For example, the NR communication system aims for an unified standard that supports all use scenarios such as enhanced Mobile BroadBand (eMBB), Ultra-Reliable Low-Latency Communication (URLLC), and massive Machine Type Communication (mMTC)), and new concepts of services and requirements are constantly being demanded. In addition, in the next-generation communication system, they are important problems to overcome inferior channel characteristics and to increase communication efficiency in the millimeter wave band and the terahertz band. Accordingly, various technologies need to be improved for this purpose.

### SUMMARY

Exemplary embodiments of the present disclosure are directed to providing a method and an apparatus for indicating beam switching quickly in high frequency band communication.

A method of a terminal, according to a first exemplary embodiment of the present disclosure, may comprise: receiving, from a base station, first unified transmission configuration indicator (TCI) information including a first TCI and a second TCI; receiving, from the base station, first downlink control information (DCI) including first scheduling information of a first physical downlink shared channel (PDSCH) and information indicating at least one TCI among the first TCI and the second TCI belonging to the first unified TCI information; and performing a first reception operation for the first PDSCH based on the at least one TCI and the first scheduling information.

The first DCI may further include second unified TCI information including a third TCI and a fourth TCI.

The at least one TCI and the second unified TCI information may be indicated by one field or different fields within the first DCI, and the first DCI may further include information indicating an application time of the second unified TCI information.

The method may further comprise: receiving, from the base station, second DCI including second scheduling information of a second PDSCH and information indicating one or more TCIs among the third TCI and the fourth TCI belonging to the second unified TCI information; and performing a second reception operation for the second PDSCH based on the one or more TCIs and the second scheduling information.

The first PDSCH may be scheduled within a first period to which the first unified TCI information is applied, and the second PDSCH may be scheduled within a second period to which the second unified TCI information is applied.

The method may further comprise: receiving, from the base station, information indicating to perform a reception operation for downlink (DL) data based on a single TCI, wherein the first reception operation may be performed based on one of the first TCI and the second TCI.

When performing of a reception operation for DL data based on multiple TCIs is not configured to the terminal, the first reception operation may be performed based on one of the first TCI and the second TCI.

A method of a terminal, according to a second exemplary embodiment of the present disclosure, may comprise: receiving, from a base station, first unified transmission configuration indicator (TCI) information including a first TCI and a second TCI; receiving, from the base station, first downlink control information (DCI) including first scheduling information of a first physical downlink shared channel (PDSCH); selecting one TCI among the first TCI and the second TCI based on a predefined rule; and performing a first reception operation for the first PDSCH based on the one TCI belonging to the first unified TCI information and the first scheduling information.

The predefined rule may be to select a first-numbered TCI, a TCI with a lowest index, or a TCI with a highest index from among the first TCI and the second TCI belonging to the first unified TCI information.

The predefined rule may be to select a default TCI among the first TCI and the second TCI belonging to the first unified TCI information when a scheduling offset between the first DCI and the first PDSCH is less than or equal to a reference value.

When information indicating to perform a reception operation for downlink (DL) data based on a single TCI is received from the base station or when performing of the reception operation for the DL data based on multiple TCIs is not configured to the terminal, the first reception operation may be performed based on the one TCI among the first TCI and the second TCI.

The first DCI may further include second unified TCI information including a third TCI and a fourth TCI.

The method may further comprise: receiving, from the base station, second DCI including second scheduling information of a second PDSCH; selecting one TCI among the third TCI and the fourth TCI belonging to the second unified TCI information indicated by the first DCI; and performing a second reception operation for the second PDSCH based on the one TCI belonging to the second unified TCI information and the second scheduling information.

A method of a base station, according to a third exemplary embodiment of the present disclosure, may comprise: transmitting, to a terminal, first unified transmission configuration indicator (TCI) information including a first TCI and a second TCI; transmitting, to the terminal, first downlink control information (DCI) including first scheduling information of a first physical downlink shared channel (PDSCH) and information indicating at least one TCI among the first TCI and the second TCI belonging to the first unified TCI information; and transmitting, to the terminal, the first PDSCH based on the at least one TCI and the first scheduling information.

The first DCI may further include second unified TCI information including a third TCI and a fourth TCI.

The at least one TCI and the second unified TCI information may be indicated by one field or different fields within the first DCI, and the first DCI may further include information indicating an application time of the second unified TCI information.

The method may further comprise: transmitting, to the terminal, second DCI including second scheduling information of a second PDSCH and information indicating one or more TCIs among the third TCI and the fourth TCI belonging to the second unified TCI information; and transmitting, to the terminal, the second PDSCH based on the one or more TCIs and the second scheduling information.

The first PDSCH may be scheduled within a first period to which the first unified TCI information is applied, and the second PDSCH may be scheduled within a second period to which the second unified TCI information is applied.

The method may further comprise: transmitting, to the terminal, information indicating to perform a reception operation for downlink (DL) data based on a single TCI, wherein the first PDSCH may be transmitted based on one of the first TCI and the second TCI.

When performing of a reception operation for DL data based on multiple TCIs is not configured to the terminal, the first PDSCH may be transmitted based on one of the first TCI and the second TCI.

According to the present disclosure, a base station may inform a terminal of a plurality of unified TCIs, and may inform the terminal of at least one unified TCI applied to a PDSCH among the plurality of unified TCIs. In this case, the terminal may receive the PDSCH based on at least one unified TCI indicated by the base station. Alternatively, the terminal may select a unified TCI based on a predefined rule, and may receive the PDSCH based on the selected unified TCI. According to the above-described unified TCI indication method and/or selection method, a beam switching operation can be quickly performed in the terminal, and performance of the communication system can be improved.

### BRIEF DESCRIPTION OF DRAWINGS

FIG. 1 is a conceptual diagram illustrating a first exemplary embodiment of a communication system;

FIG. 2 is a block diagram illustrating a first exemplary embodiment of an apparatus constituting a communication system;

FIG. 3 is a conceptual diagram illustrating a first exemplary embodiment of a TCI indication method by DCI.

FIG. 4 is a conceptual diagram illustrating a first exemplary embodiment of a method for applying a unified TCI to a plurality of signals.

FIG. 5 is a conceptual diagram illustrating a second exemplary embodiment of a method for applying a unified TCI to a plurality of signals.

FIG. 6 is a conceptual diagram illustrating a first exemplary embodiment of a unified TCI indication method for multi-TRP transmission.

FIG. 7 is a conceptual diagram illustrating a second exemplary embodiment of a unified TCI indication method for multi-TRP transmission.

FIG. 8 is a conceptual diagram illustrating a third exemplary embodiment of a unified TCI indication method for multi-TRP transmission.

FIG. 9 is a conceptual diagram illustrating a first exemplary embodiment of a method for determining a TCI to be applied to a scheduled PDSCH.

FIG. 10 is a conceptual diagram illustrating a second exemplary embodiment of a method for determining a TCI to be applied to a scheduled PDSCH.

FIG. 11 is a conceptual diagram illustrating a third exemplary embodiment of a method for determining a TCI to be applied to a scheduled PDSCH.

FIG. 12 is a conceptual diagram illustrating a first exemplary embodiment of a method of applying TCI(s) to a CORESET in a multi-unified TCI period.

FIG. 13 is a conceptual diagram illustrating a first exemplary embodiment of a PDCCH monitoring method using a plurality of TCIs within a CORESET pool.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

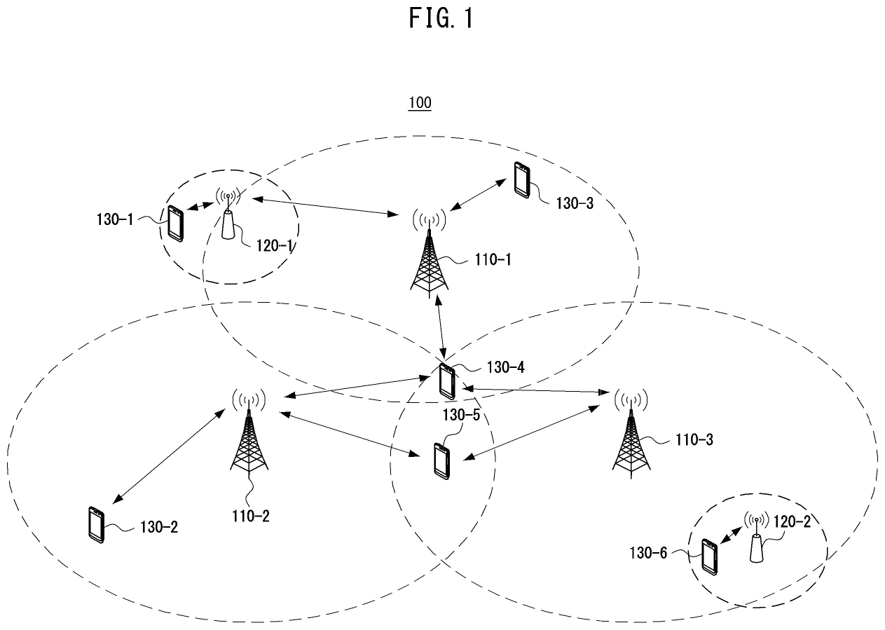

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

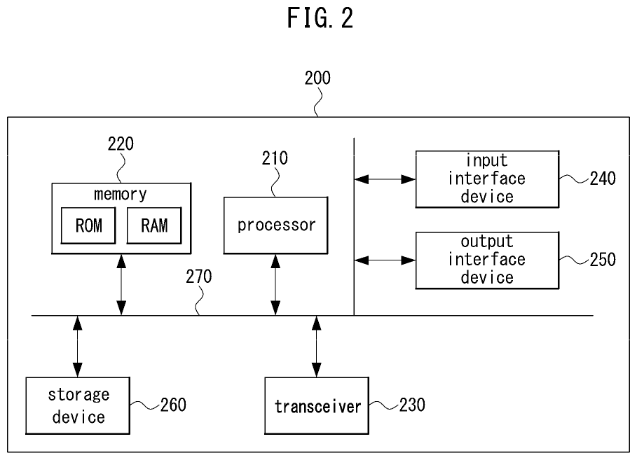

FIG. 2 is a block diagram illustrating a first exemplary embodiment of an apparatus constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

The present disclosure may relate to techniques for transmitting and receiving signals in a communication system. A method and an apparatus for performing multi-transmission point-based signal transmission and beam management in a wireless communication system will be described. Exemplary embodiments of the present disclosure may be applied to the NR communication system. In addition, the exemplary embodiments of the present disclosure may be applied not only to the NR communication system but also to other communication systems (e.g., LTE communication system, 5G communication system, 6G communication system, or the like).

A numerology applied to physical signals and channels in the communication system (e.g., NR communication system or 6G communication system) may be variable. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have an exponential multiplication relationship of 2, and the CP length may be scaled at the same ratio as the OFDM symbol length. Depending on a frequency band in which the communication system operates, at least some numerologies among the numerologies of Table 1 may be supported. In addition, in the communication system, numerologies not listed in Table 1 may be further supported. CP type(s) not listed in Table 1 (e.g., extended CP) may be additionally supported for a specific subcarrier spacing (e.g., 60 kHz).

TABLE 1

| Subcarrier | | | | | | |
|---|---|---|---|---|---|---|
| spacing | 15 kHz | 30 kHz | 60 kHz | 120 kHz | 240 kHz | 480 kHz |
| OFDM symbol | 66.7 | 33.3 | 16.7 | 8.3 | 4.2 | 2.1 |
| length [μs] | | | | | | |
| CP length [μs] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

In the following description, a frame structure in the communication system will be described. In the time domain, elements constituting a frame structure may include a subframe, slot, mini-slot, symbol, and the like. The subframe may be used as a unit for transmission, measurement, and the like, and the length of the subframe may have a fixed value (e.g., 1 ms) regardless of a subcarrier spacing. A slot may comprise consecutive symbols (e.g., 14 OFDM symbols). The length of the slot may be variable differently from the length of the subframe. For example, the length of the slot may be inversely proportional to the subcarrier spacing.

A slot may be used as a unit for transmission, measurement, scheduling, resource configuration, timing (e.g., scheduling timing, hybrid automatic repeat request (HARD) timing, channel state information (CSI) measurement and reporting timing, etc.), and the like. The length of an actual time resource used for transmission, measurement, scheduling, resource configuration, etc. may not match the length of a slot. A mini-slot may include consecutive symbol(s), and the length of a mini-slot may be shorter than the length of a slot. A mini-slot may be used as a unit for transmission, measurement, scheduling, resource configuration, timing, and the like. A mini-slot (e.g., the length of a mini-slot, a mini-slot boundary, etc.) may be predefined in the technical specification. Alternatively, a mini-slot (e.g., the length of a mini-slot, a mini-slot boundary, etc.) may be configured (or indicated) to the terminal. When a specific condition is satisfied, use of a mini-slot may be configured (or indicated) to the terminal.

The base station may schedule a data channel (e.g., physical downlink shared channel (PDSCH), physical uplink shared channel (PUSCH), physical sidelink shared channel (PSSCH)) using some or all of symbols constituting a slot. In particular, for URLLC transmission, unlicensed band transmission, transmission in a situation where an NR communication system and an LTE communication system coexist, and multi-user scheduling based on analog beamforming, a data channel may be transmitted using a portion of a slot. In addition, the base station may schedule a data channel using a plurality of slots. In addition, the base station may schedule a data channel using at least one mini-slot.

In the frequency domain, elements constituting the frame structure may include a resource block (RB), subcarrier, and the like. One RB may include consecutive subcarriers (e.g., 12 subcarriers). The number of subcarriers constituting one RB may be constant regardless of a numerology. In this case, a bandwidth occupied by one RB may be proportional to a subcarrier spacing of a numerology. An RB may be used as a transmission and resource allocation unit for a data channel, control channel, and the like. Resource allocation of a data channel may be performed in units of RBs or RB groups (e.g., resource block group (RBG)). One RBG may include one or more consecutive RBs. Resource allocation of a control channel may be performed in units of control channel elements (CCEs). One CCE in the frequency domain may include one or more RBs.

In the NR communication system, a slot (e.g., slot format) may be composed of a combination of one or more of downlink period, flexible period (or unknown period), and an uplink period. Each of a downlink period, flexible period, and uplink period may be comprised of one or more consecutive symbols. A flexible period may be located between a downlink period and an uplink period, between a first downlink period and a second downlink period, or between a first uplink period and a second uplink period. When a flexible period is inserted between a downlink period and an uplink period, the flexible period may be used as a guard period.

A slot may include one or more flexible periods. Alternatively, a slot may not include a flexible period. The terminal may perform a predefined operation in a flexible period. Alternatively, the terminal may perform an operation configured by the base station semi-statically or periodically. For example, the periodic operation configured by the base station may include a PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, and the like. A flexible symbol may be overridden by a downlink symbol or an uplink symbol. When a flexible symbol is overridden by a downlink or uplink symbol, the terminal may perform a new operation instead of the existing operation in the corresponding flexible symbol (e.g., overridden flexible symbol).

A slot format may be configured semi-statically by higher layer signaling (e.g., radio resource control (RRC) signaling). Information indicating a semi-static slot format may be included in system information, and the semi-static slot format may be configured in a cell-specific manner. In addition, a semi-static slot format may be additionally configured for each terminal through terminal-specific higher layer signaling (e.g., RRC signaling). A flexible symbol of a slot format configured cell-specifically may be overridden by a downlink symbol or an uplink symbol by terminal-specific higher layer signaling. In addition, a slot format may be dynamically indicated by physical layer signaling (e.g., slot format indicator (SFI) included in downlink control information (DCI)). The semi-statically configured slot format may be overridden by a dynamically indicated slot format. For example, a semi-static flexible symbol may be overridden by a downlink symbol or an uplink symbol by SFI.

The base station and the terminal may perform downlink operations, uplink operations, and sidelink operations in a bandwidth part. A bandwidth part may be defined as a set of consecutive RBs (e.g., physical resource blocks (PRBs)) having a specific numerology in the frequency domain. RBs constituting one bandwidth part may be consecutive in the frequency domain. One numerology may be used for transmission of signals (e.g., transmission of control channel or data channel) in one bandwidth part. In exemplary embodiments, when used in a broad sense, a ‘signal’ may refer to any physical signal and channel. A terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology (e.g., a subcarrier spacing and a CP length) applied to the bandwidth part. Also, the configuration information of the bandwidth part may further include information indicating a position of a start RB (e.g., start PRB) of the bandwidth part and information indicating the number of RBs (e.g., PRBs) constituting the bandwidth part. At least one bandwidth part among the bandwidth part(s) configured in the terminal may be activated. For example, within one carrier, one uplink bandwidth part and one downlink bandwidth part may be activated respectively. In a time division duplex (TDD) based communication system, a pair of an uplink bandwidth part and a downlink bandwidth part may be activated. The base station may configure a plurality of bandwidth parts to the terminal within one carrier, and may switch the active bandwidth part of the terminal.

In exemplary embodiments, an RB may mean a common RB (CRB). Alternatively, an RB may mean a PRB or a virtual RB (VRB). In the NR communication system, a CRB may refer to an RB constituting a set of consecutive RBs (e.g., common RB grid) based on a reference frequency (e.g., point A). Carriers, bandwidth part, and the like may be arranged on the common RB grid. In other words, a carrier, bandwidth part, etc. may be composed of CRB(s). An RB or CRB constituting a bandwidth part may be referred to as a PRB, and a CRB index within the bandwidth part may be appropriately converted into a PRB index. In an exemplary embodiment, an RB may refer to an interlace RB (IRB).

A minimum resource unit constituting a PDCCH may be a resource element group (REG). An REG may be composed of one PRB (e.g., 12 subcarriers) in the frequency domain and one OFDM symbol in the time domain. Thus, one REG may include 12 resource elements (REs). A demodulation reference signal (DMRS) for demodulating a PDCCH may be mapped to 3 REs among 12 REs constituting the REG, and control information (e.g., modulated DCI) may be mapped to the remaining 9 REs.

One PDCCH candidate may be composed of one CCE or aggregated CCEs. One CCE may be composed of a plurality of REGs. The NR communication system may support CCE aggregation levels 1, 2, 4, 8, 16, and the like, and one CCE may consist of six REGs.

A control resource set (CORESET) may be a resource region in which the terminal performs a blind decoding on PDCCHs. The CORESET may be composed of a plurality of REGs. The CORESET may consist of one or more PRBs in the frequency domain and one or more symbols (e.g., OFDM symbols) in the time domain. The symbols constituting one CORESET may be consecutive in the time domain. The PRBs constituting one CORESET may be consecutive or non-consecutive in the frequency domain. One DCI (e.g., one DCI format or one PDCCH) may be transmitted within one CORESET. A plurality of CORESETs may be configured with respect to a cell and a terminal, and the plurality of CORESETs may overlap in time-frequency resources.

A CORESET may be configured in the terminal by a PBCH (e.g., system information or a master information block (MIB) transmitted on the PBCH). The identifier (ID) of the CORESET configured by the PBCH may be 0. That is, the CORESET configured by the PBCH may be referred to as a CORESET #0. A terminal operating in an RRC idle state may perform a monitoring operation in the CORESET #0 in order to receive a first PDCCH in the initial access procedure. Not only terminals operating in the RRC idle state but also terminals operating in the RRC connected state may perform monitoring operations in the CORESET #0. The CORESET may be configured in the terminal by other system information (e.g., system information block type 1 (SIB1)) other than the system information transmitted through the PBCH. For example, for reception of a random access response (or Msg2) in a random access procedure, the terminal may receive the SIB1 including the configuration information of the CORESET. Also, the CORESET may be configured in the terminal by terminal-specific higher layer signaling (e.g., RRC signaling).

In each downlink bandwidth part, one or more CORESETs may be configured for the terminal. The terminal may monitor PDCCH candidate(s) for the CORESET configured in the downlink active bandwidth part. Alternatively, the terminal may monitor PDCCH candidate(s) for a CORESET (e.g., CORESET #0) configured in a downlink bandwidth part other than the downlink active bandwidth part. The initial downlink active bandwidth part may include the CORESET #0 and may be associated with the CORESET #0. The CORESET #0 having a quasi-co-location (QCL) relationship with a synchronization signal block (SSB) may be configured for the terminal in a primary cell (PCell), a secondary cell (SCell), and a primary secondary cell (PSCell). In the secondary cell (SCell), the CORESET #0 may not be configured for the terminal.

In the present disclosure, a synchronization signal block (SSB) may mean a set of signal(s) and/or channel(s) including a synchronization signal. For example, the SSB may include a primary synchronization signal (PSS) and/or a secondary synchronization signal (SSS). In addition, the SSB may further include a physical broadcast channel (PBCH), a DM-RS for decoding (or demodulation) of the PBCH (hereinafter referred to as ‘PBCH DM-RS’), a CSI-RS, and the like. In other words, the SSB may include the PSS, SSS, PBCH, PBCH DM-RS, and/or CSI-RS. The SSB may be repeatedly transmitted periodically, and within one period, the SSB may be transmitted one or more times. When a plurality of SSBs are transmitted in a plurality of SSB resources, the plurality of SSBs may correspond to different beams. In the NR communication system, the SSB may be referred to as an SS/PBCH block.

A search space may be a set of candidate resource regions through which PDCCHs can be transmitted. The terminal may perform a blind decoding on each of the PDCCH candidates within a predefined search space. The terminal may determine whether a PDCCH is transmitted to itself by performing a cyclic redundancy check (CRC) on a result of the blind decoding. When it is determined that a PDCCH is a PDCCH for the terminal itself, the terminal may receive the PDCCH. The terminal may periodically monitor the search space, and may monitor the search space at one or more time locations (e.g., PDCCH monitoring occasions, CORESET) within one period.

A PDCCH candidate may be configured with CCEs selected by a predefined hash function within an occasion of the CORESET or the search space. The search space may be defined and configured for each CCE aggregation level. In this case, a set of search spaces for all CCE aggregation levels may be referred to as a ‘search space set’. In exemplary embodiments, ‘search space’ may mean ‘search space set’, and ‘search space set’ may mean ‘search space’.

A search space set may be logically associated with one CORESET. One CORESET may be logically associated with one or more search space sets. A search space set for transmitting common DCI or group common DCI may be referred to as a common search space set (hereinafter, referred to as a ‘CSS set’). The common DCI or the group common DCI may include at least one of resource allocation information of a PDSCH for transmission of system information, paging, a power control command, SFI, or a preemption indicator. In the case of the NR communication system, the common DCI may correspond to DCI formats 0_0, 1_0, etc. A cyclic redundancy check (CRC) of the common DCI may be scrambled by a system information-radio network temporary identifier (SI-RNTI), paging-RNTI (P-RNTI), random access-RNTI (RA-RNTI), temporary cell-RNTI (TC-RNTI), or the like. The group common DCI having the scrambled CRS may be transmitted. The group common DCI may correspond to a DCI format 2_X. Here, X may be an integer equal to or greater than 0. A CRC of the group common DCI may be scrambled by a slot format indicator-RNTI (SFI-RNTI) or the like. The group common DCI having the scrambled CRC may be transmitted. The CSS set may include Type 0, Type 0A, Type 1, Type 2, and Type 3 CSS sets.

A search space set for transmitting a terminal-specific (i.e., UE-specific) DCI may be referred to as a UE-specific search space set (hereinafter, referred to as a ‘USS set’). The UE-specific DCI may include scheduling and resource allocation information for a PDSCH, PUSCH, PSSCH, or the like. In the NR communication system, the UE-specific DCI may correspond to DCI formats 0_1, 0_2, 1_1, 1_2, 3_0, 3_1, or the like. A CRC of the UE-specific DCI may be scrambled by a cell (C)-RNTI, configured scheduling-RNTI (CS-RNTI), modulation and coding scheme-C-RNTI (MCS-C-RNTI), or the like. The UE-specific DCI having the scrambled CRC may be transmitted. In consideration of scheduling freedom or fallback transmission, a UE-specific DCI may be transmitted even in a CSS set. In this case, the UE-specific DCI may be transmitted according to the DCI format corresponding to the common DCI. For example, the terminal may monitor a PDCCH (e.g., DCI formats 0_0, 0_1) whose CRC is scrambled with a C-RNTI, CS-RNTI, MCS-C-RNTI, or the like in the CSS set.

The Type 0 CSS set may be used for receiving a DCI scheduling a PDSCH including an SIB1, and may be configured through a PBCH or cell-specific RRC signaling. The ID of the Type 0 CSS set may be assigned as or set to 0. The type 0 CSS set may be logically combined with the CORESET #0.

The terminal may improve channel estimation performance or form a transmission/reception beam by using large-scale propagation properties of a radio channel. The large-scale propagation properties in channels experienced by a first signal and a second signal transmitted from the base station to the terminal may be the same. In other words, a quasi-co-location (QCL) relationship may be established between the first signal and the second signal. In addition, large-scale propagation properties in channels experienced by a third signal and a fourth signal transmitted from the terminal to the base station may be the same. In other words, a QCL relationship may be established between the third signal and the fourth signal. In addition, a QCL relationship may be established between the first signal, which is a downlink signal, and the third signal, which is an uplink signal. Several large-scale propagation properties may be defined as QCL parameters. For example, the QCL parameters may include a delay spread, a Doppler spread, a Doppler shift, an average gain, an average delay, spatial reception (Rx) parameter(s), and the like. The spatial reception parameters may correspond to properties such as a reception beam, a reception channel spatial correlation, and a transmission/reception beam pair. For convenience, the spatial reception parameters may be referred to as ‘spatial QCL’. A set of QCL parameter(s) may be referred to as ‘QCL type’. In the NR communication system, the QCL types may include a Type A, Type B, Type C, Type D, and the like. The Type D QCL may include spatial reception parameters and may correspond to the spatial QCL.

The base station may signal a ‘transmission configuration indicator (TCI) state’ or ‘TCI’, which is information indicating a QCL relationship between signals, to the terminal. In the present disclosure, ‘TCI state’ and ‘TCI’ may be used interchangeably. When large-scale propagation properties of a first signal are equally applied to a second signal, the first signal and the second signal may be referred to as a QCL source signal and a QCL target signal, respectively. The TCI state may include at least one of information on a QCL source signal (e.g., ID of a source signal) and information on QCL parameter(s) (or QCL Type) with which a QCL relationship is established. The QCL source signal may include an SSB, a synchronization signal, a reference signal (e.g., CSI-RS, DM-RS), a physical channel, and/or the like. The QCL target signal may include a reference signal, a physical channel, and a DM-RS of a physical channel. The QCL source signal and the QCL target signal may be downlink physical signals or channels. Alternatively, the QCL source signal and the QCL target signal may be uplink physical signals or channels. Transmission directions of the QCL source signal and the QCL target signal may be the same or different.

A QCL relationship for a PDCCH may be established. The terminal may assume that the PDCCH (e.g., PDCCH DM-RS) has a QCL relationship with a certain signal. The certain signal may be a QCL source signal. The QCL relationship may be determined based on configuration or indication of a TCI. Alternatively, the QCL relationship may be determined by a rule predefined in technical specifications. The terminal may perform channel estimation and beamforming operations for PDCCH reception based on the QCL relationship.

The same TCI or QCL relationship may be applied within one CORESET. In other words, the terminal may perform a monitoring operation (or a reception operation) for all search space sets or PDCCH candidates belonging to the same CORESET based on the same QCL relationship. The TCI or QCL relationship applied to each CORESET may be configured by the base station. Alternatively, the TCI or QCL relationship applied to each CORESET may be derived by a predefined rule. The QCL relationship of a specific CORESET may be determined based on an initial access or random access procedure of the terminal. For example, the CORESET 0 may have a QCL relationship with an SSB selected in the initial access procedure, a recently transmitted PRACH in the random access procedure, or the like. Alternatively, the TCI or QCL relationship may be applied for each search space set. In this case, different TCIs or different QCL relationships may be applied in monitoring operations of a plurality of search space sets within the same CORESET.

Meanwhile, beam operations in a high frequency band and a low frequency band in the communication system may be different from each other. Since a path loss of a signal due to a channel is relatively small in a low frequency band (e.g., a band of 6 GHz or below), the signal may be transmitted and received using a beam having a wide beamwidth. Abeam having a wide beamwidth may be referred to as a wide beam. Especially in transmission of a control channel, the entire coverage of a cell (or sector) may be covered even with a single beam. However, in a high-frequency band (e.g., a band of 6 GHz or above) in which a path loss of a signal is large, beamforming using a large-scale antenna may be used to increase a signal reach. In addition, beamforming may be applied to a common signal and a control channel as well as a data channel. A communication node (e.g., base station) may form a beam having a narrow beamwidth through multiple antennas, and transmit and receive a signal multiple times by using a plurality of beams having different directivity to cover the entire spatial coverage of a cell (or sector). A beam having a narrow beamwidth may be referred to as a narrow beam. An operation of repeatedly transmitting a signal in a plurality of time resources using a plurality of beams may be referred to as a beam sweeping operation. A system that transmits a signal using a plurality of narrow beams may be referred to as a multi-beam system.

The multi-beam system may operate based on beam management. The terminal may measure a beam quality of a received signal (e.g., SSB, CSI-RS, etc.) and report the measured quality to the base station. For example, the terminal may calculate a layer 1-reference signal received power (L1-RSRP), layer 1-signal-to-interference-plus-noise ratio (L1-SINR), etc. for each beam (e.g., each signal, each resource), and report optimal beam(s) and measurement value(s) corresponding thereto to the base station. The base station may determine a transmission beam for the terminal based on the beam quality measurement information reported from the terminal. In addition, the base station may configure, to the terminal, a TCI for transmission or reception of a physical signal and channel (e.g., PDCCH, PDSCH, CSI-RS, PUCCH, PUSCH, SRS, PRACH, etc.) of the terminal based on the beam quality measurement information received from the terminal.

In the present disclosure, the TCI may be used in the meaning of a narrow concept of a beam, a type D QCL, beam indication information, beam indication signaling, and the like. That is, ‘beam’ and ‘TCI’ may be used interchangeably. In particular, the above definition may be established in exemplary embodiments related to operations of the multi-beam system. A downlink TCI or a TCI for downlink signal reception may correspond to a reception beam, and an uplink TCI or a TCI for uplink signal transmission may correspond to a transmission beam. The transmission beam may mean spatial relation information, a transmission spatial filter, and the like.

Multiple beams may be formed by a plurality of TRPs and/or panels. In the present disclosure, a TRP and a panel may be collectively referred to as ‘TRP’. The TRPs may be deployed based on different spatial locations, antenna shapes, boresights, and the like, and thus, a different beam (e.g., transmission beam, reception beam, transmission/reception beam pair) may be formed for each channel formed between the TRPs and the terminal. The base station may perform multi-beam transmission using multiple TRPs, and transmission reliability can be improved by a beam selection gain or a beam diversity gain. The multi-TRP transmission scheme may be referred to as ‘coordinated multipoint (CoMP) scheme’. TRPs participating in multi-TRP transmission may belong to the same base station or the same serving cell. Alternatively, TRPs participating in multi-TRP transmission may belong to a plurality of base stations (e.g., different base stations) or a plurality of serving cells (e.g., different serving cells). As a backhaul environment between the TRPs, an ideal backhaul and a non-ideal backhaul may be considered. It may be difficult to apply joint scheduling between TRPs connected by the non-ideal backhaul.

[Beam (TCI) Indication Method]

A PDCCH reception beam (e.g., TCI) and a PDSCH reception beam (e.g., TCI) of the terminal may be individually managed by the base station. A TCI of a PDCCH may be configured for a CORESET corresponding to the PDCCH. The terminal may perform PDCCH monitoring and reception operations in a search space set or PDCCH candidate corresponding to the CORESET based on a TCI state included in configuration information of the CORESET. In the present disclosure, a signal reception operation based on a TCI may include operations such as determining and applying a reception beam and estimating a channel. A TCI of a PDSCH may be configured or indicated separately from the TCI of the PDCCH. The TCI of the PDSCH may be dynamically indicated to the terminal by being included in DCI for scheduling the PDSCH. The base station may select one TCI from candidate TCI(s) of the PDSCH, which are configured or activated through higher layer signaling to the terminal, and may indicate the selected TCI through the scheduling DCI. In the case of multi-TRP transmission, the DCI may include a plurality of TCIs, and the terminal may receive the PDSCH using the indicated plurality of TCIs. In addition, a TCI of another downlink signal (e.g., CSI-RS, TRS, PRS) may be determined independently of the TCI of the PDCCH or PDSCH.

In uplink communication, a PUCCH transmission beam (e.g., TCI) and a PUSCH transmission beam (e.g., TCI) of the terminal may be individually managed. A TCI (e.g., transmission spatial filter or spatial relation information) of a PUCCH may be semi-statically configured in the terminal. A TCI (e.g., transmission spatial filter or spatial relation information) of a PUSCH may be semi-statically configured in the terminal. Alternatively, the TCI of the PUSCH may be included in scheduling DCI. In other words, the TCI of the PUSCH may be dynamically indicated to the terminal. The TCI of the PUSCH may be indirectly indicated by SRS resource indication information, and the terminal may apply a TCI the same as a TCI (e.g., transmission spatial filter or spatial relation information) configured to an indicated SRS resource to the PUSCH, and transmit the PUSCH. In addition, a TCI of another uplink signal (e.g., SRS and PRACH) may be determined independently of the TCI of the PUCCH or PUSCH.

According to the above-described method, since individual beam management is possible for each transmission signal or channel, a high degree of freedom and flexibility can be secured in radio resource management of the base station. However, when a beam is to be changed collectively for a plurality of signals for the terminal, an individual signaling procedure for each signal may be required. The individual signaling procedure may cause high signaling overhead and long delay time.

In order to solve the above problem, a method of controlling a TCI of a plurality of signals (specifically, physical signals and/or physical channels) with one signaling for the terminal may be considered. In downlink communication, the terminal may identify a downlink TCI through DCI, and the downlink TCI indicated by the DCI may be applied to both a PDCCH and a PDSCH. In addition, the indicated downlink TCI may be applied to downlink signals (e.g., CSI-RS, TRS, PRS) other than the PDCCH and PDSCH. In uplink communication, the terminal may identify an uplink TCI through DCI, and the uplink TCI indicated by the DCI may be applied to both a PUCCH and a PUSCH. In addition, the indicated uplink TCI may be applied to uplink signals (e.g., SRS and PRACH) other than the PUCCH and PUSCH. The downlink TCI and the uplink TCI may be individually indicated through different DCIs. Alternatively, the downlink TCI and the uplink TCI may be indicated together by the same DCI. Also, the downlink TCI and the uplink TCI may coincide. In this case, the TCI may be referred to as a joint TCI. The joint TCI may be indicated to the terminal through DCI, and may be applied to all of the above-described downlink signals (e.g., PDCCH, PDSCH, and other signal(s)) and the above-described uplink signals (e.g., PUCCH, PUSCH, and other signal(s)). The above-described TCI may be referred to as a unified TCI, single TCI, or the like in the sense that it is equally applied to a plurality of signals (specifically, physical signals and/or physical channels).

A signal to which the unified TCI is applied may be a signal for transmitting terminal-specific information. For example, the PDSCH may include unicast data (e.g., DL-SCH). The PDCCH may include DCI for scheduling a data channel (e.g., PDSCH, PUSCH, PSSCH) including unicast data or DCI including terminal-specific control information. The PDCCH may be a PDCCH transmitted in a USS set and/or a specific CSS set (e.g., Type 3 CSS set). In addition, the CSI-RS, TRS, PRS, etc. may be a terminal-specifically configured and transmitted signal. For another example, the PUSCH may include unicast data (e.g., UL-SCH). In addition, the SRS, PRACH, etc. may be a terminal-specifically configured and transmitted signal. The above-described terminal-specific signal may be configured in the terminal through a terminal (UE)-specific RRC signaling procedure, MAC CE, DCI, and/or the like.

The unified TCI may be indicated by DCI. For example, a downlink DCI format (e.g., DCI format 1_0, 1_1, 1_2) including PDSCH scheduling information may be used for TCI indication. Alternatively, a downlink DCI format (e.g., DCI format 1_0, 1_1, 1_2) that does not include PDSCH scheduling information may be used for TCI indication.

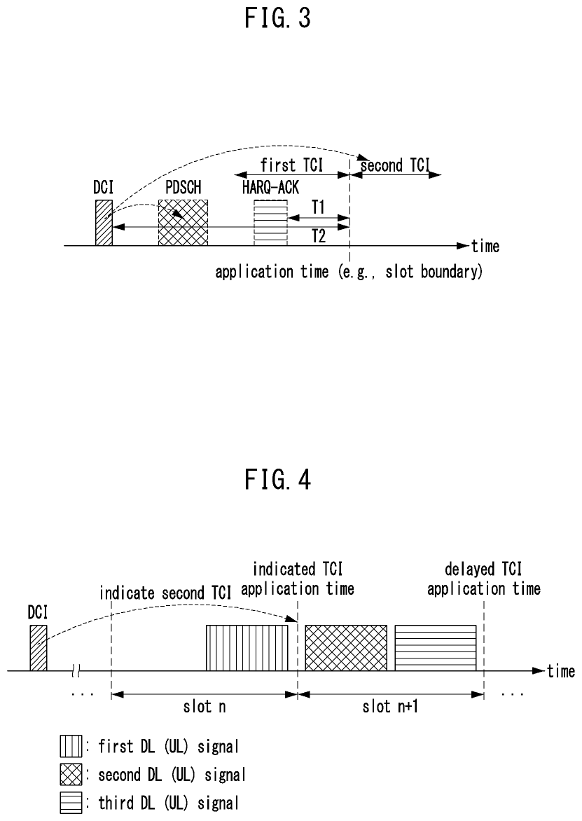

FIG. 3 is a conceptual diagram illustrating a first exemplary embodiment of a TCI indication method by DCI.

Referring to FIG. 3, the base station may transmit downlink DCI including TCI indication information. The terminal may receive the downlink DCI including the TCI indication information. In addition, the terminal may identify PDSCH scheduling information included in the downlink DCI. Alternatively, the downlink DCI may not include PDSCH scheduling information. In this case, specific field(s) of the DCI may be set to a predefined value or used for other purposes. The terminal may report HARQ-acknowledgement (HARQ-ACK) to the base station as a reception response for the scheduled PDSCH or the downlink DCI. The HARQ-ACK may be set to ACK or negative ACK (NACK) according to whether the scheduled PDSCH or the downlink DCI is successfully received. Alternatively, the HARQ-ACK may be transmitted to the base station only when the scheduled PDSCH or the downlink DCI is successfully received. In this case, the HARQ-ACK may always be set to ACK. A transmission resource (e.g., PUCCH resource) of the HARQ-ACK may be determined based on a resource location of the received PDSCH. When a PDSCH is not scheduled by the DCI, the transmission resource of the HARQ-ACK may be determined based on a virtual (or nominal) PDSCH resource allocated by the DCI.

As a specific method of TCI indication, the base station may instruct the terminal to switch a TCI. In this case, the base station may indicate a TCI to the terminal only when TCI switching is required, and the TCI indicated by the DCI may necessarily be different from the previous TCI. In other words, in the above-described exemplary embodiment (e.g., the exemplary embodiment of FIG. 3), a second TCI may be different from a first TCI. Alternatively, the base station may indicate to the terminal a TCI to be applied. In this case, the indicated TCI (e.g., the TCI to be applied) may be the same as or different from the previous TCI, and the terminal may switch the TCI only when the indicated TCI is different from the previous TCI. In other words, both a case where the second TCI is the same as the first TCI and a case where the second TCI is different from the first TCI may be allowed in the above-described exemplary embodiment (e.g., the exemplary embodiment of FIG. 3). The TCI switched by the above-described operation may be one of a downlink TCI, an uplink TCI, and a joint TCI.

Referring to FIG. 3, an application time of the TCI indication may be determined by a time offset (e.g., T2) from a reception time of the DCI indicating the TCI. Alternatively, the HARQ-ACK corresponding to the DCI may be transmitted to the base station, and the application time of the TCI indication may be determined by a time offset (e.g., T1) from a transmission time of the HARQ-ACK. In addition, the TCI indication may be applied from a boundary (e.g., start time or start symbol) of a slot. The start symbol of the slot may be the first symbol of the slot. Combining the above characteristics, the application time of the TCI may be determined as a first slot (e.g., a start time of the slot, the first symbol of the slot) appearing first after a predetermined number of symbols from a reference symbol (e.g., the last symbol) among symbols in which the HARQ-ACK is transmitted. In other words, T1 may mean a symbol distance between the last symbol of the HARQ-ACK and the first symbol of the first slot. Alternatively, the application time of the TCI may be determined as the first slot (i.e., a start time of the slot, the first symbol of the slot) appearing first after a predetermined number of symbols from a reference symbol (e.g., the last symbol) among symbols in which the DCI is received. In other words, T2 may mean a symbol distance between the last symbol of the DCI and the first symbol of the first slot. Here, the predetermined number of symbols may be predefined in technical specifications, and may have different values according to a subcarrier spacing, an operating frequency band, and a capability of the terminal.

When a set of signals to which the unified TCI is applied is referred to as a set S, the application time of the TCI may be equally applied to all signals constituting the set S. If the application time of the TCI is a first slot, the terminal may apply the indicated TCI (e.g., unified TCI) to all signals constituting the set S from the first slot. This may be referred to as (Method 100). Even when (Method 100) is used, a TCI of a signal not included in the set S may operate separately from the DCI and an application time of the DCI. In exemplary embodiments, the set S may include downlink signal(s), uplink signal(s), or ‘downlink signal(s) and uplink signal(s)’ depending on a case. For example, when an uplink unified TCI and a downlink unified TCI are separately indicated and managed, the set S may be individually defined for uplink (e.g., uplink signals) and downlink (e.g., downlink signals). For another example, when the unified uplink TCI and the unified downlink TCI are jointly indicated and managed, the set S may include both uplink signals and downlink signals to which the unified TCI is applied.

On the other hand, the unified TCI may be applied at different times to the plurality of signals constituting the set S. This may be referred to as (Method 110). In (Method 110), a plurality of signal groups may be configured, and each signal group may include signal(s) to which the unified TCI is applied. In addition, a plurality of application times of the TCI (or a plurality of corresponding time offsets) may be configured to the terminal. For example, a first TCI application time (or first time offset) and a second TCI application time (or second time offset) may be configured to the terminal, and the first TCI application time and the second TCI application time may be applied to a first signal group and a second signal group, respectively. Each signal group may be explicitly configured by the base station. Additionally or alternatively, signals to which the unified TCI is applied may be grouped based on TRPs to which the signals belong, serving cells to which the signals belong, panels for transmitting and receiving the signals, and/or the like.

As a similar method, the terminal may generally apply one TCI application time to the indicated TCI. However, the terminal may apply other TCI application times to exceptional signal(s). The exceptional signal(s) may mean signal(s) that satisfy a specific condition or signal(s) that do not satisfy a specific condition. This may be referred to as (Method 111). Hereinafter, exemplary embodiments supporting (Method 111) will be described.

FIG. 4 is a conceptual diagram illustrating a first exemplary embodiment of a method for applying a unified TCI to a plurality of signals.

Referring to FIG. 4, the terminal may receive DCI, and the DCI may indicate a downlink unified TCI or joint unified TCI. A previous downlink TCI may be a first TCI, and the DCI may instruct the terminal to apply a second TCI to downlink signals. An application time of the second TCI may be a slot (n+1). The terminal may apply the second TCI to reception of downlink signals included in a set S from the slot (n+1). In other words, the first TCI may be applied to a first downlink signal shown in FIG. 4 and the second TCI may be applied to a second downlink signal shown in FIG. 4.

Each of the first downlink signal and the second downlink signal may be one of a PDCCH, PDSCH, or CSI-RS. A resource of the first downlink signal and a resource of the second downlink signal may be configured or indicated independently. An association relationship between the resource of the first downlink signal and the resources of the second downlink signal may not exist. For example, the first downlink signal may be a first PDSCH corresponding to a first TB, and the second downlink signal may be a second PDSCH corresponding to a second TB. The first PDSCH and the second PDSCH may be scheduled by different signaling (e.g., different DCIs). At least one of the first PDSCH and the second PDSCH may be an SPS PDSCH allocated by semi-persistent scheduling. For another example, the first downlink signal may be a PDSCH included in the set S, and the second downlink signal may be a CSI-RS (e.g., aperiodic CSI-RS) included in the set S. For another example, the first downlink signal may be a PDCCH included in the set S, and the second downlink signal may be a PDSCH. In the above-described exemplary embodiment, the first TCI, which is the previous TCI, may be applied to the first downlink signal, and the second TCI, which is the indicated TCI, may be applied to the second downlink signal.

Meanwhile, by (Method 111), the application time of the indicated TCI may be exceptionally different for some signals constituting the set S. In the above-described exemplary embodiment, a third downlink signal may be a signal associated with the first downlink signal. For example, the first downlink signal and the third downlink signal may be PDSCHs (or PDSCH instances) constituting repeated PDSCH transmission. In other words, the first downlink signal and the third downlink signal may respectively correspond to a first PDSCH instance and a second PDSCH instance repeatedly transmitted for the same TB(s). In this case, the same TCI may be applied to reception of the PDSCH instances constituting the repeated PDSCH transmission for the same TB.

According to a proposed method, the above-described rule may take precedence over the TCI indication by the DCI. In other words, the TCI (e.g., first TCI) applied to the first PDSCH instance may be equally applied to the third downlink signal corresponding to the second PDSCH instance instead of the TCI (e.g., second TCI) indicated by the DCI. Although the third downlink signal is transmitted in a period to which the indicated TCI is applied, the indicated TCI may not be applied to the third downlink signal exceptionally. In other words, the application time of the TCI indicated for the signal may be delayed. The application time of the indicated TCI may be delayed in units of slots. The application time of the indicated TCI may be delayed by N slots from a slot which is an original application time of the indicated TCI. N may be a natural number. The repeated PDSCH transmission may be dynamically scheduled by DCI. Alternatively, the repeated PDSCH transmission may correspond to an SPS PDSCH.

Among target signals constituting the set S, the TCI (e.g., first TCI) actually applied to the third downlink signal may be equally applied to a signal belonging to the same slot (or the same subframe, the same subslot, etc.) as the third downlink signal. According to this, the terminal may apply the first TCI to the second downlink signal as well as the third downlink signal. The terminal may apply the previous TCI (e.g., first TCI) to the slot (n+1) to which the third downlink signal belongs, and may apply the indicated TCI (e.g., second TCI) to a slot (e.g., slot (n+2)) after the slot (n+1). In other words, the TCI application time may be collectively delayed for all signals constituting the set S. Generalizing the above-described exemplary embodiment, if at least one signal to which the indicated TCI is not applied exceptionally exists in a certain slot after the TCI application time, the indicated TCI may not be applied to all the target signals in the certain slot, and the TCI application time may be delayed after the certain slot. In this case, the delayed TCI application time may be the earliest slot to which a signal to which the indicated TCI is not applied exceptionally is not mapped among slots appearing after the original TCI application time indicated by the DCI. Alternatively, the delayed TCI application time may be the earliest slot to which a signal to which the indicated TCI is not applied exceptionally is not mapped and a signal belonging to the set S is mapped among the slots appearing after the original TCI application time indicated by the DCI. According to the method described above, the terminal may apply only one TCI to at least to signals belonging to the set S within one slot. Therefore, the complexity of beam management and transmission/reception of the terminal can be reduced.

Alternatively, a signal to which the previous TCI is applied exceptionally (e.g., a signal to which the delayed TCI application time is applied) may be limited to a signal that satisfies an exception condition, and the indicated TCI may be applied to other signals belonging to the same slot as the signal among the target signals according to the normal TCI application time (e.g., nominal TCI application time). The above-described method may correspond to (Method 111). According to this, the terminal may apply the first TCI, which is the previous TCI, to the third downlink signal, and apply the second TCI, which is the indicated TCI, to the second downlink signal. As another method, the previous TCI may be equally applied to some signals among other target signals belonging to the same slot as the signal to which the previous TCI is exceptionally applied, and the indicated TCI may be normally applied to some other signals. The signal to which the previous TCI is applied and the signal to which the indicated TCI is applied may be determined based on relative resource locations with respect to the exceptional signal. For example, the same TCI as the exceptional signal may be applied to a signal transmitted earlier or not later than the exceptional signal, and the indicated TCI may be normally applied to a signal transmitted later than or not earlier than the exceptional signal. In other words, the time at which the TCI is applied may be determined as one symbol (e.g., the first symbol) to which the exceptional signal is mapped within the indicated slot. The indicated TCI may be applied to a signal starting in the one symbol or after the one symbol among the signals belonging to the set S. In other words, the application time of the indicated TCI may be delayed in units of symbols. In other words, the application time of the indicated TCI may be delayed by M symbols (or by N slots and M symbols) from the first symbol of the slot according to the original application time. Each of M and N may be a natural number.

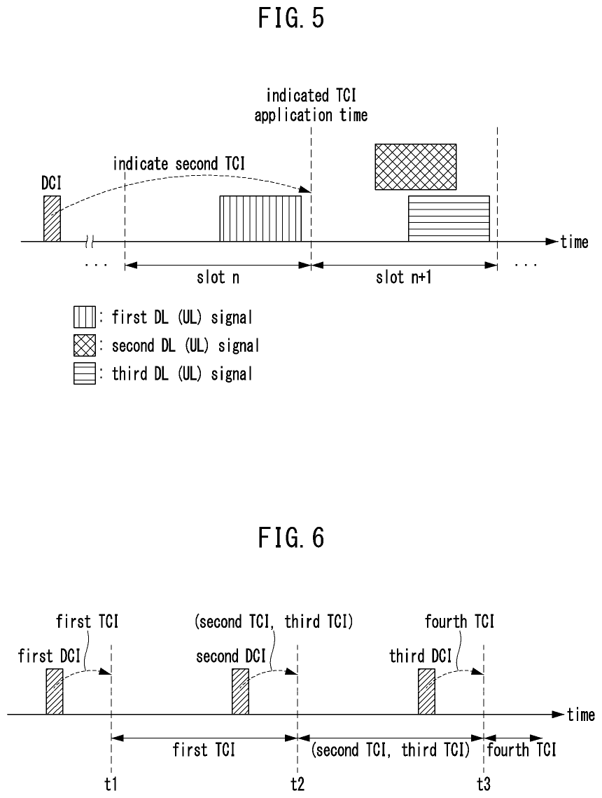

FIG. 5 is a conceptual diagram illustrating a second exemplary embodiment of a method for applying a unified TCI to a plurality of signals.

A difference between the second exemplary embodiment of FIG. 5 and the first exemplary embodiment of FIG. 4 may be that the second downlink signal and the third downlink signal overlap in time. In other words, the previous downlink TCI may be the first TCI, and the terminal may receive DCI indicating application of the second TCI to downlink signals and/or uplink signals from the slot (n+1). In this case, when a resource of the second downlink signal overlaps with a resource of the third downlink signal or when the TCI indicated for the second downlink signal and the TCI indicated for the third downlink signal are different, the terminal may selectively receive one downlink signal from among the downlink signals according to a prioritization rule. When the terminal receives the third downlink signal, the same TCI as the TCI of the first downlink signal may be applied to the third downlink signal instead of the indicated TCI by the method described above. When the terminal receives the second downlink signal, the second TCI which is the indicated TCI may be normally applied to the second downlink signal. In other words, whether to apply the indicated TCI, whether to delay the TCI application time, etc. may be determined based on a priority or actual reception of the third downlink signal associated with the signal of the previous slot. Meanwhile, the terminal may expect to receive both the overlapping second downlink signal and third downlink signal. In this case, the same TCI may be applied to the downlink signals, and the TCI may be determined as the previous TCI or the indicated TCI by the above-described method.

In an exemplary embodiment, a unified TCI may be indicated to the terminal, and a first signal belonging to the set S and a second signal not belonging to the set S may temporally overlap in a period (e.g., slot) to which the unified TCI is applied. When the first signal and the second signal are downlink signals, the terminal may receive either one of the first signal and the second signal according to a prioritization rule. In addition, when the first signal and the second signal are uplink signals, the terminal may transmit either one of the first signal and the second signal according to a prioritization rule. The terminal may preferentially receive or transmit the first signal belonging to the set S (e.g., signal to which the unified TCI is applied). In this case, the terminal may not receive or transmit the second signal not belonging to the set S. Alternatively, the terminal may receive or transmit the second signal based on the TCI (e.g., unified TCI) applied to the first signal. Alternatively, different TCIs may be applied to symbol(s) overlapping with the first signal and symbol(s) not overlapping with the first signal among symbols to which the second signal is mapped. For example, the unified TCI may be applied to symbol(s) overlapping with the first signal among the symbols to which the second signal is mapped, and the indicated TCI may be applied to symbol(s) not overlapping with the first signal among the symbols to which the second signal is mapped.

The above-described method of determining the TCI application time according to the transmission priority may be more effective for uplink transmission. Referring to FIG. 5, the first uplink signal and the third uplink signal may be signals associated with each other, and the second uplink signal and the third uplink signal may temporally overlap in the slot (n+1). In this case, the terminal may selectively transmit one uplink signal among the uplink signals according to a prioritization rule. According to the method described above, when the terminal transmits the third uplink signal, the same TCI as that of the first uplink signal may be applied to the third uplink signal instead of the indicated TCI. When the terminal transmits the second uplink signal, the indicated TCI may be normally applied to the second uplink signal. In other words, whether to apply the indicated TCI, whether to delay the TCI application time, etc. may be determined based on a priority or actual transmission of the third uplink signal associated with the signal of the previous slot. Meanwhile, the terminal may transmit both the overlapping second uplink signal and third uplink signal. Alternatively, the terminal may be expected to transmit at least both of the overlapping second uplink signal and third uplink signal. In this case, the same TCI may be applied to the uplink signals, and the TCI may be determined as the previous TCI or the indicated TCI by the above-described method.

As another method of applying a unified TCI to a plurality of signals, even when a first signal before an application time of the indicated unified TCI and a second signal after the application time are associated with each other according to a predetermined reason (e.g., repeated transmission, included in the same CSI-RS resource set, included in the same SRS resource set, etc.), the indicated unified TCI may be applied to the second signal and other signals (e.g., all signals of the set S) in the corresponding period as it is. In addition, the previous TCI may be applied to the first signal and other signals (e.g., all signals of the set S) in the corresponding period. In the exemplary embodiments of FIGS. 4 and 5, according to the above-described method, the terminal may apply the unified TCI (e.g., second TCI) indicated by the DCI to the second downlink signal and the third downlink signal. Alternatively, the terminal may apply the unified TCI (e.g., second TCI) indicated by the DCI to the second uplink signal and the third uplink signal. The terminal may apply the first TCI, which is the previous TCI, to the first downlink signal or the first uplink signal.

As another method of applying a unified TCI to a plurality of signals, the terminal may not expect to receive an indication to apply a unified TCI at a time between resources of a first signal and a second signal associated with each other. Alternatively, the terminal may not expect to receive an indication (e.g., an indication for a unified TCI switching operation) to apply different unified TCIs to the resources of the first signal and the second signal associated with each other. According to the latter method, in the exemplary embodiments of FIGS. 4 and 5, applying the unified TCI (e.g., second TCI) from the slot (n+1) may be indicated to the terminal, and the second TCI may be the same as the first TCI, which is the previous TCI.

In the above-described exemplary embodiment, the first downlink signal and the third downlink signal may be PDCCHs constituting repeated PDCCH transmission. For example, the first downlink signal and the third downlink signal may respectively correspond to a first PDCCH candidate and a second PDCCH candidate that are linked to or associated with each other. The PDCCH candidates linked to each other may belong to the same CORESET and may be configured to be monitored based on the same TCI. Alternatively, the PDCCH candidates linked to each other may belong to different CORESETs and may be configured to be monitored based on respective TCIs of the different CORESETs. In this case, an operation of applying the unified TCI to the first PDCCH candidate and the second PDCCH candidate may be the same as the above-described operation.

In the above-described exemplary embodiment, the first downlink signal and the third downlink signal may correspond to a first CSI-RS and a second CSI-RS, respectively, and the terminal may be configured to receive the first CSI-RS and the second CSI-RS based on the same beam or the same TCI. For example, the first CSI-RS and the second CSI-RS may respectively correspond to a first CSI-RS resource and a second CSI-RS resource belonging to the same CSI-RS resource set. Repeated transmission may be configured for the first CSI-RS resource and the second CSI-RS resource. The terminal may measure beam quality(ies) (e.g., L1-RSRP, L1-SINR) based on the received first CSI-RS and second CSI-RS, and report the measurement result to the base station. In this case, an operation of applying the unified TCI to the first CSI-RS and the second CSI-RS may be the same as the above-described operation.

For example, the indicated TCI may not be applied to the second CSI-RS. The previous TCI (e.g., TCI applied to the slot n) may be applied to the second CSI-RS. Accordingly, the same unified TCI may be applied to the first CSI-RS and the second CSI-RS, and TCI switching may not occur. The above-described method may be generally applied to CSI-RS resources transmitted repeatedly M times (e.g., CSI-RS resources belonging to the same CSI-RS resource set). M may be a natural number. For another example, the terminal may not expect to receive an indication to apply the TCI at a boundary time between the first CSI-RS resource and the second CSI-RS resource. Alternatively, the terminal may not expect to receive an indication for applying different TCIs to the first CSI-RS and the second CSI-RS. As a result, the terminal may receive repeatedly transmitted CSI-RSs based on the same TCI. For another example, the second TCI, which is the indicated unified TCI, may be applied to the second CSI-RS. The first TCI, which is the previous TCI, may be applied to the first CSI-RS. As a result, the repeatedly transmitted CSI-RSs may be received based on different TCIs.

As yet another example, in the above-described case, the terminal may omit reception of some CSI-RSs. The terminal may receive the first CSI-RS based on the previous TCI and may omit the reception operation of the second CSI-RS. In other words, the terminal may omit the reception operation of CSI-RS(s) after the application time of the indicated TCI. Alternatively, the terminal may not receive both the first CSI-RS and the second CSI-RS. In other words, the terminal may omit the reception operation of all repeatedly transmitted CSI-RSs. The latter method may be used when the terminal has already recognized the TCI indication or acquired the indicated TCI before starting the reception operation of the first-numbered CSI-RS constituting the repeated transmission (e.g., the first CSI-RS). The above-described method may equally be applied not only to repeated CSI-RS transmissions, but also to the above-described repeated PDSCH transmission, the above-described repeated PDCCH transmission, and/or repeated uplink signal transmission to be described later. In other words, the first CSI-RS and the second CSI-RS may be generalized to a first signal and a second signal associated with each other.

The terminal may perform a radio resource management (RRM) measurement operation (e.g., RSRP, RSRQ, and SINR measurement), radio link monitoring (RLM) measurement operation, beam quality measurement operation, etc. based on the repeatedly transmitted CSI-RSs (or CSI-RSs configured to apply the same TCI), and report measurement results to the base station. When the repeatedly transmitted CSI-RSs are received based on different TCIs, the terminal may perform the measurement operation using only a part of the CSI-RS(s). The same TCI may be applied to the part of the CSI-RS(s). The base station may determine a transmission beam for the terminal based on the report.

As described above, the above-described exemplary embodiments may be implemented for uplink transmission. The operation of the terminal in the above-described exemplary embodiments may be applied to the first uplink signal, the second uplink signal, and the third uplink signal. The first uplink signal and the third uplink signal may be signals associated with each other. For example, the first uplink signal and the third uplink signal may be PUSCHs (or PUSCH instances) constituting repeated PUSCH transmission, PUCCHs (or PUCCH instances) constituting repeated PUCCH transmission, or repeatedly-transmitted SRSs. For example, the first uplink signal and the third uplink signal may mean a first SRS (or first SRS resource) and a second SRS (or second SRS resource) constituting the same SRS resource set, respectively. In this case, an operation of determining the TCI to be applied to each uplink signal by the terminal may be the same as or similar to the operation described in the above-described exemplary embodiments.

In the above-described exemplary embodiment, the first uplink signal and the third uplink signal may be PUSCH(s) for one TB. Alternatively, when the number of transmission layers is greater than or equal to a reference value, the first uplink signal and the third uplink signal may be PUSCH(s) for two TBs. For example, one PUSCH including the one TB may be mapped to both a resource of the first uplink signal and a resource of the third uplink signal. In other words, one PUSCH may be mapped to a plurality of slots.

In addition, in the above-described exemplary embodiment, the terminal may apply joint channel estimation to the first uplink signal and the third uplink signal, and the joint channel estimation operation may be performed based on configuration information received from the base station. Each of the first uplink signal and the third uplink signal may be a PUSCH, and a DM-RS may be shared between the PUSCHs. Alternatively, each of the first uplink signal and the third uplink signal may be a PUCCH, and a DM-RS may be shared between the PUCCHs. Specifically, the DM-RS of the first uplink signal and/or a channel estimated based on the DM-RS may be used for decoding not only the first uplink signal but also the third uplink signal. The DM-RS of the third uplink signal and/or a channel estimated based on the DM-RS may be used for decoding not only the third uplink signal but also the first uplink signal. Alternatively, decoding of the first uplink signal and the third uplink signal may be performed based on the DM-RS of the first uplink signal and/or the DM-RS of the third uplink signal. To support the above operation, a time domain window for PUSCH(s) (or PUCCH(s)) may be configured in the terminal, and the terminal may transmit the PUSCH(s) (or PUCCH(s)) by applying the same transmission power to a plurality of PUSCHs (or PUCCHs) belonging to the time window. The base station may apply the above-described joint channel estimation scheme to reception of the PUSCHs (or PUCCHs) within the time window. According to the above-described exemplary embodiments, the same unified TCI may be applied to transmission of the plurality of PUSCHs (or the plurality of PUCCHs), and based on this, the joint channel estimation scheme may be applied to the plurality of PUSCHs (or the plurality of PUCCHs).

In addition, in the above-described exemplary embodiment, the first uplink signal and the third uplink signal may respectively correspond to a first SRS and a second SRS transmitted repeatedly. The terminal may transmit the first SRS and the second SRS based on the same beam or the same TCI based on configuration information from the base station. In this case, an operation of the terminal applying the unified TCI to the second SRS may be performed in the same manner as in the above-described exemplary embodiments.

In the above-described exemplary embodiment, downlink signal(s) or uplink signal(s) may be scheduled by the DCI indicating the unified TCI. In the first exemplary embodiment of FIG. 4, the first downlink signal and the third downlink signal may be PDSCHs scheduled by the DCI indicating the unified TCI. The PDSCHs may be repeated transmissions for the same TB. Alternatively, the PDSCHs may correspond to different TBs. The first uplink signal and the third uplink signal may be PUSCHs or PUCCHs scheduled by the DCI indicating the unified TCI. The PUSCHs (or PUCCHs) may be repeated transmissions for the same TB (or the same payload). Alternatively, the PUSCHs (or PUCCHs) may correspond to different TBs (or payloads).

Referring again to FIG. 3, the indicated unified TCI may not be applied to the PDSCH scheduled by the DCI indicating the unified TCI. Specifically, when the PDSCH is allocated before an application time of the TCI, the previous TCI instead of the indicated TCI may be applied to the PDSCH. In this case, since fast beam switching is not applied to the PDSCH, the reception performance of the PDSCH may deteriorate. As a proposed method, the base station may generate the DCI (e.g., DCI indicating the unified TCI) including a separate field (e.g., identifier) and transmit the DCI to the terminal. The field of the DCI (e.g., the separate field) may be used to control the TCI of the PDSCH scheduled by the DCI. Similarly, the indication information for controlling the TCI of the PDSCH scheduled by the DCI may be transmitted to the terminal based on a unified TCI indication field (e.g., specific bit(s) or specific code point(s) of the unified TCI indication filed) within the DCI instead of the separate field. The method described above may be referred to as (Method 200).

According to an exemplary embodiment, when the identifier is set to a specific value (e.g., ‘0’), the terminal may apply the previous TCI other than the TCI indicated by the DCI to the PDSCH scheduled by the DCI. Conversely, when the identifier is set to another specific value (e.g., ‘1’), the DCI may directly indicate the TCI of the PDSCH scheduled by itself. In other words, the terminal may apply the TCI indicated by the DCI to the PDSCH scheduled by the DCI. According to another exemplary embodiment, the above-described operation may be performed based on whether the separate field exists in the DCI. For example, when the DCI includes the separate field (e.g., when the size of the separate field is 1 bit or more), the terminal may apply the TCI indicated by the DCI (e.g., the separate field) to the PDSCH scheduled by the DCI. In this case, the indicated TCI may be applied not only to the PDSCH but also to other downlink signals of a slot to which the PDSCH is mapped. Specifically, the indicated TCI may be applied to signal(s) constituting the set S among all downlink signal(s) of the slot to which the PDSCH is mapped. Alternatively, the indicated TCI may be applied to downlink signal(s) temporally overlapping (or sharing symbol(s)) with the PDSCH among the signals constituting the set S.

According to (Method 200), two TCIs may be indicated to the terminal by the same DCI (i.e., the above-described DCI). In other words, the two TCIs may include a first TCI and a second TCI. The first TCI may be a unified TCI indicated by the DCI. The second TCI may be a TCI applied to a PDSCH, CSI-RS, PUSCH, PUCCH, SRS, etc. scheduled by the DCI.

The above method may be used only when the PDSCH is earlier than an application time of the first TCI. In other words, in the above-described case, the second TCI may be applied to the PDSCH, and in the other cases, the first TCI may be applied to the PDSCH. Alternatively, the above-described method may be generally used regardless of a scheduling timing of the PDSCH. Even when the PDSCH is mapped after the application time of the first TCI, the second TCI may be applied to the PDSCH instead of the first TCI. In other words, the unified TCI may be replaced by the separately indicated TCI. Alternatively, a priority may be considered between the first TCI and the second TCI. The terminal may select one of the two TCIs based on a predefined prioritization rule or a prioritization rule configured by the base station, and may receive the PDSCH based on the selected TCI. Alternatively, when the PDSCH is mapped after the application time of the first TCI, the terminal may not expect that the first TCI and the second TCI are indicated differently.

[Indication Method of Multiple TRP Beams (TCIs)]

Meanwhile, in an environment where multiple TRPs are deployed, signals may be transmitted and received by a plurality of TRPs. Downlink signals (e.g., PDSCH, PDCCH) may be transmitted from the plurality of TRPs to the terminal, and uplink signals (e.g., PUSCH, PUCCH) may be transmitted from the terminal to the plurality of TRPs. The terminal may apply different downlink TCIs (or different downlink beams) to reception of the downlink signals transmitted from the plurality of TRPs, and may apply different uplink TCIs (or different uplink beams) to transmission of the uplink signals transmitted to the plurality of TRPs.

Multi-TRP transmission may be scheduled by single DCI. For example, one downlink DCI may schedule a plurality of PDSCHs, and a plurality of downlink TCIs may be applied to the plurality of PDSCHs. In addition, one uplink DCI may schedule a plurality of PUSCHs or a plurality of PUCCHs, and a plurality of uplink TCIs may be applied to the plurality of PUSCHs or the plurality of PUCCHs. The PDSCHs (or PUSCHs) may be PDSCH instances (or PUSCH instances) constituting repeated PDSCH transmission (or repeated PUSCH transmission) for the same TB. Alternatively, the PDSCHs (or PUSCHs) may be PDSCHs (or PUSCHs) corresponding to different TBs.

Alternatively, multi-TRP transmission may be scheduled by a plurality of DCIs respectively transmitted from a plurality of TRPs. A CORESET pool may be configured in the terminal to support the above-described operation. For example, the terminal may receive configuration information of a first CORESET pool and a second CORESET pool, and each CORESET pool may include one or more CORESET(s). Alternatively, for some purposes, a specific CORESET pool may be configured as an empty CORESET pool that does not include CORESETs. A TCI for PDCCH monitoring may be configured for each CORESET pool. In other words, CORESETs belonging to the same CORESET pool may be monitored based on the same TCI. One TCI may be configured for each CORESET pool. Alternatively, a plurality of TCIs may be configured for a certain CORESET pool. In this case, a PDCCH may be transmitted in the CORESET pool based on a single frequency network (SFN) scheme, and the terminal may monitor the PDCCH using all of the plurality of TCIs.

When the terminal performs multi-TRP transmission, a plurality of unified TCIs may be indicated to the terminal. DCI indicating the unified TCIs may indicate a plurality of unified TCIs for the same transmission direction, and the terminal may perform a downlink reception operation or an uplink transmission operation based on the indicated plurality of unified TCIs. For example, two downlink unified TCIs, two uplink unified TCIs, or two joint unified TCIs may be indicated through the DCI. The base station may configure the terminal to apply the multiple unified TCIs.

FIG. 6 is a conceptual diagram illustrating a first exemplary embodiment of a unified TCI indication method for multi-TRP transmission.

Referring to FIG. 6, the terminal may identify one or a plurality of unified TCI(s) through DCI. In other words, the DCI may indicate one or a plurality of unified TCI(s) to the terminal. For example, for downlink and/or uplink, first DCI may indicate a first TCI, second DCI may indicate a second TCI and a third TCI, and third DCI may indicate a fourth TCI. In other words, one unified TCI may be indicated to the terminal for a certain period, and multiple (e.g., two) unified TCIs may be indicated to the terminal for another certain period. The number of unified TCIs indicated to the terminal by the DCI may be dynamically changed.

Start times (e.g., start slots) at which the indicated plurality of unified TCIs are applied may be the same. For example, the second TCI and the third TCI indicated by the second DCI may be simultaneously applied from a time t2 (or, slot corresponding to t2). The terminal may receive (or monitor) a downlink signal transmitted in the application period of the second TCI and the third TCI based on at least one of the second TCI and the third TCI. In addition, the terminal may apply the first TCI, which is the previous TCI, until before the application period of the second TCI and the third TCI. According to the above-described method, a beam adaptation operation of the terminal and a beam management procedure of the base station may be simplified, and implementation complexity of the terminal and the base station may be reduced.

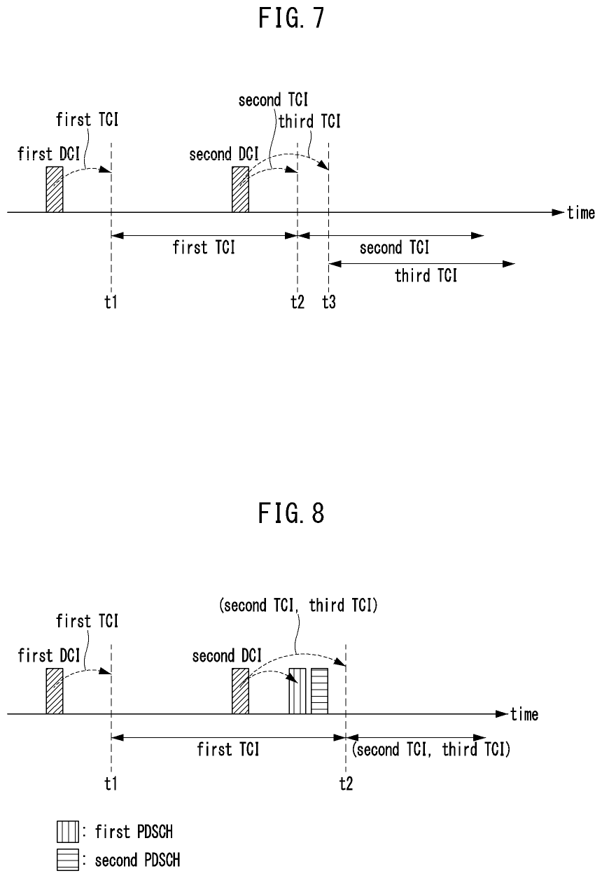

FIG. 7 is a conceptual diagram illustrating a second exemplary embodiment of a unified TCI indication method for multi-TRP transmission.

Referring to FIG. 7, similarly to the exemplary embodiment of FIG. 6, the terminal may identify one or a plurality of unified TCI(s) through DCI. In other words, the DCI may indicate one or a plurality of unified TCI(s) to the terminal. For example, for downlink and/or uplink, first DCI may indicate a first TCI, and second DCI may indicate a second TCI and a third TCI. According to the exemplary embodiment of FIG. 7, the TCIs may be applied at different times. The second TCI may be applied from a time t2 or a slot corresponding to t2, and the third TCI may be applied from a time t3 or a slot corresponding to t3. As a result, both the second TCI and the third TCI may be applied to a period starting from t3. In this case, the first TCI, which is the previous TCI, may be applied until before the time t2 and may not be applied after the time t2. Alternatively, the first TCI may be used together with the second TCI in a period between t2 and t3 before the third TCI is applied. For example, the terminal may perform a reception operation of downlink signals (e.g., repeatedly transmitted PDSCHs) based on the first TCI and the second TCI in slot(s) between t2 and t3.

Generalizing the above-described operation, when application of multiple unified TCIs (or N unified TCIs) is configured to the terminal, and a single unified TCI (or TCIs less than N unified TCIs) is indicated to the terminal for a predetermined period, the terminal may transmit and receive signal(s) by applying the multiple unified TCIs (or N unified TCIs) in the predetermined period. In an exemplary embodiment where N=2, the two unified TCIs may include the indicated one unified TCI and the previous TCI (e.g., TCI applied to a period prior to the predetermined period). Alternatively, the two unified TCIs may include the indicated one unified TCI and a default TCI (or reference TCI). An operation in which the terminal determines the default TCI may be predefined in technical specifications. For example, a TCI recently used for monitoring the CORESET or a TCI configured or activated for PDSCH reception may be used as the default TCI.

FIG. 8 is a conceptual diagram illustrating a third exemplary embodiment of a unified TCI indication method for multi-TRP transmission.

Referring to FIG. 8, similarly to the exemplary embodiment of FIG. 6 and/or FIG. 7, the terminal may identify one or a plurality of unified TCI(s) through DCI. In other words, the DCI may indicate one or a plurality of unified TCI(s) to the terminal. For downlink and/or uplink, a first TCI may be indicated by first DCI, and a second TCI and a third TCI may be indicated by second DCI. In addition, a first PDSCH and a second PDSCH may be scheduled by the second DCI. For example, the first PDSCH and the second PDSCH may be PDSCH instances constituting repeated PDSCH transmission. In addition, the first PDSCH and the second PDSCH may respectively correspond to a special case of a first signal and a second signal, which are associated with each other (e.g., repeatedly transmitted). In this case, regardless of the unified TCI indicated by the second DCI, a TCI applied to a time period (e.g., slot) to which the first PDSCH and the second PDSCH are allocated may be applied in reception of the first PDSCH and the second PDSCH. The first PDSCH and the second PDSCH may be received based on the first TCI. In other words, the repeated PDSCH transmission may be transmitted by a single TRP.

On the other hand, unlike the above-described exemplary embodiment, the first PDSCH and the second PDSCH scheduled by the DCI may belong to different TCI periods. For example, the first PDSCH may be allocated to a slot before t2, and the second PDSCH may be allocated to a slot after t2 or corresponding to t2. In this case, similarly to the above-described operation, the TCI applied to each PDSCH may be a TCI applied to the TCI period to which each PDSCH belongs. For example, the first TCI, which is the previous TCI, may be applied to the first PDSCH, and at least one of the second TCI or the third TCI, which are unified TCIs indicated by the DCI, may be applied to the second PDSCH. A rule for the terminal to select the at least one TCI may be predefined in technical specifications. For example, the at least one TCI may be determined based on TCI indexes of the unified TCIs, a TCI configuration order of the unified TCIs, TCI indexes of the unified TCIs within a TCI pool, and/or the like. Alternatively, the same TCI(s) may be applied to the first PDSCH and the second PDSCH. In this case, the first TCI applied to the first PDSCH, which is the first-numbered PDSCH, may be equally applied to the second PDSCH. Alternatively, the terminal may not expect that the first PDSCH and the second PDSCH are allocated to belong to different TCI periods. The different TCI periods may mean TCI periods to which different TCI(s) are indicated.

Transmission based on a single TCI may be allocated in the period to which the multiple unified TCIs are indicated. For example, a signal transmitted once without repeated transmission, a signal configured to be received based on one TCI, and the like may be allocated in the period to which the second TCI and the third TCI are indicated. The signal may include a downlink signal such as a PDCCH, PDSCH, and CSI-RS or an uplink signal such as a PUCCH, PUSCH, and SRS. In this case, the signal may be received based on the unified TCI(s) indicated to the period to which the signal is allocated rather than the TCI configured for the signal. The method described above may be referred to as (Method 300). In the following exemplary embodiment, (Method 300) will be described in detail.

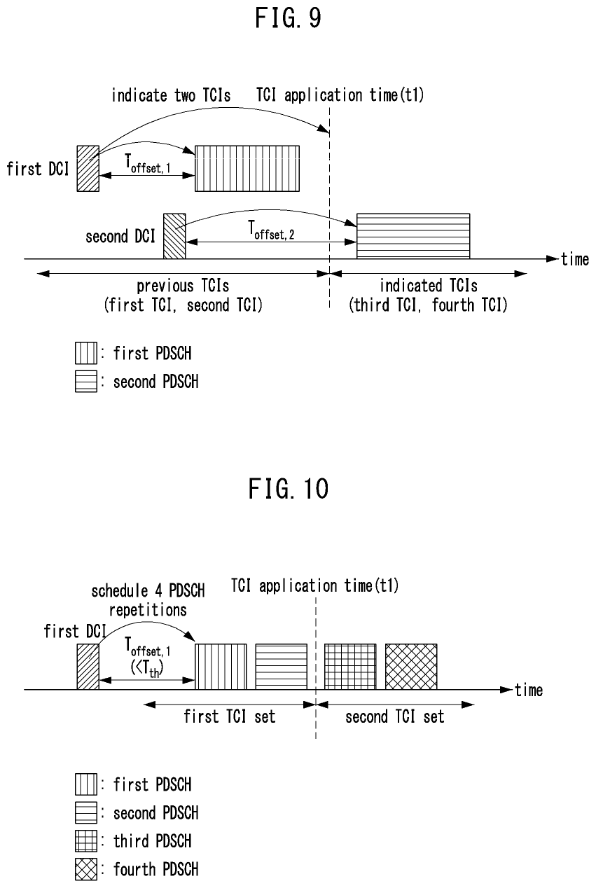

FIG. 9 is a conceptual diagram illustrating a first exemplary embodiment of a method for determining a TCI to be applied to a scheduled PDSCH.

Referring to FIG. 9, the terminal may receive first DCI and identify scheduling information of a first PDSCH based on the received first DCI. In addition, the terminal may receive second DCI, and may identify scheduling information of a second PDSCH based on the received second DCI. The terminal may identify unified TCI(s) through the DCI. In other words, the DCI may indicate the unified TCI(s) to the terminal. For example, the first DCI may indicate the terminal to apply two unified TCIs (e.g., third TCI and fourth TCI). An application time of the indicated TCIs, which is denoted as t1 in the drawing, may mean a first slot, a start symbol of the first slot, or a start boundary of the first slot. The terminal may receive a downlink signal based on the first TCI and the second TCI, which are previous TCIs, until a slot previous to the first slot, and may receive a downlink signal based on the third TCI and the fourth TCI, which are indicated TCIs, from the first slot.

According to (Method 300), the base station may transmit a first PDSCH and a second PDSCH based on a single TCI in the period to which multiple unified TCIs (e.g., unified TCI information) are indicated. As a preliminary procedure for the above-described operation, the terminal may receive, from the base station, information (e.g., configuration information) instructing to perform an operation of receiving a PDSCH (e.g., downlink channel, downlink data) based on a single TCI. Alternatively, as a procedure corresponding to the above-described procedure, the base station may not configure the terminal to perform an operation of receiving a PDSCH based on multiple TCIs. The configuration may be applied to each bandwidth part or each serving cell (or each serving cell group). In this case, the first PDSCH and the second PDSCH may be received based on a TCI indicated to a period to which each PDSCH is allocated. For example, the first PDSCH may be received based on one TCI among the first TCI and the second TCI, which are a plurality of unified TCIs indicated to a period to which the first PDSCH is allocated, and the second PDSCH may be received based on one TCI among the third TCI and the fourth TCI, which are a plurality of unified TCIs indicated to a period to which the second PDSCH is allocated.

An operation of the terminal selecting one TCI to be applied to PDSCH reception from among the plurality of unified TCIs may be performed according to a predefined rule. For example, the first-numbered TCI, a TCI with the lowest index, a TCI with the highest index, or the like may be selected from among the indicated unified TCI(s) (e.g., TCI pair). Specifically, among TCIs indicated by the RRC parameter, MAC CE, DCI bits, or DCI codepoint for unified TCI configuration, the ‘first-numbered TCI’ may mean a TCI having a first order, the earliest TCI, a TCI indicated earlier, a TCI corresponding to the most signification bit(s) (MSB(s)), a TCI corresponding to the least signification bit(s) (LSB(s)), or the like. In the above-described exemplary embodiment, the first TCI and the third TCI may correspond to the above-described first-numbered TCI and the like, and the first TCI and the third TCI may be respectively applied to the first PDSCH and the second PDSCH according to the above rule. Alternatively, the base station may configure or indicate to the terminal one TCI to be applied to PDSCH reception among the plurality of unified TCIs through a signaling procedure. Similarly, the one TCI may mean a TCI having a specific order in a TCI pair or TCIs described in a message.

As another method, the one TCI to be applied to PDSCH reception among the plurality of unified TCIs may be dynamically indicated to the terminal by (Method 200). As described above, information indicating the one TCI may be included in the DCI (e.g., DCI format 1_0, 1_1, 1_2, etc.) for scheduling the PDSCH. In addition, the scheduling DCI may include information indicating the unified TCI(s). In the first exemplary embodiment of FIG. 9, the scheduling DCI may correspond to the first DCI. The terminal may identify the unified TCIs (e.g., the third TCI and the fourth TCI) through the first DCI, and apply the unified TCIs to a downlink reception operation (e.g., reception operation of downlink signal(s) included in the set S) from the time t1. In addition, the terminal may identify one TCI to be applied to reception of the first PDSCH through the first DCI. The one TCI may be one of the first TCI and the second TCI, which are unified TCIs for a period in which the first PDSCH is scheduled. The one TCI may be determined by the base station. The information indicating the one TCI may belong to the same DCI field as that of indication information of the unified TCIs. Alternatively, the information indicating the one TCI and the information indicating the unified TCIs may belong to different fields within the DCI. When repeated PDSCH transmission is scheduled, the information indicating the one TCI may be applied to all PDSCHs constituting repeated transmission. However, a TCI actually applied to each PDSCH constituting the repeated transmission may be the same or different depending on the unified TCI(s) indicated to a slot to which each PDSCH is allocated.

Meanwhile, a start time (e.g., start symbol, start slot) of the PDSCH may be dynamically indicated by the DCI that schedules the PDSCH. In this case, a time offset (e.g., symbol offset) between the start symbol of the PDSCH and an end symbol of the scheduling DCI may be referred to as a scheduling offset of the PDSCH. When the scheduling offset is greater than or equal to a reference value (or threshold), the terminal may obtain TCI indication information included in the scheduling DCI before starting the PDSCH reception operation, and may receive the PDSCH based on the indicated TCI (e.g., TCI indication information). On the other hand, when the scheduling offset is equal to or less than (or less than) the reference value, the terminal may not be able to obtain the TCI indication information included in the scheduling DCI before starting the PDSCH reception operation, and may receive the PDSCH based on another TCI other than the indicated TCI. The another TCI may be referred to as a default TCI for convenience. The default TCI may be determined as one TCI among unified TCI(s) applied to the period in which the PDSCH is scheduled. The reference value or threshold may be expressed by the number of symbols and/or the number of slots corresponding to a PDCCH decoding time of the terminal. The reference value or threshold may be predefined in technical specifications. Alternatively, the reference value or threshold may be transmitted from the base station to the terminal through a signaling procedure.

The above-described exemplary embodiment may be performed in combination with the above-described PDSCH reception operation based on the default TCI. Referring again to FIG. 9, the scheduling offset of the first PDSCH may be expressed as T_{offset,1}. T_{offset,1} may be less than the reference value. The terminal may receive the first PDSCH based on the default TCI. The default TCI may be determined as one of the first TCI and the second TCI, which are unified TCI(s) applied to the period (e.g., slot) to which the PDSCH is allocated. For example, the terminal may determine the first TCI, which is the first-numbered TCI of the period, as the default TCI for receiving the first PDSCH. In the same manner, the terminal may determine the third TCI, which is the first-numbered TCI in a period after t1, as the default TCI for receiving the second PDSCH. For another example, the default TCI may be determined as one TCI among TCI(s) recently applied to control channel (e.g., PDCCH) monitoring. The default TCI may be determined as a TCI applied to one CORESET among CORESET(s) mapped to the latest slot to which at least one CORESET is mapped. Alternatively, the default TCI may be determined as one of TCI(s) configured or activated for PDSCH transmission.

Meanwhile, the scheduling DCI may not include the information indicating the one TCI to be applied to reception of the PDSCH. For example, a field corresponding to the information (e.g., TCI indication information) may not exist in the scheduling DCI. Alternatively, the size of the field corresponding to the information (e.g., TCI indication information) in the scheduling DCI may be 0. In this case, the terminal may equally apply the TCI applied to reception of the scheduling DCI (or CORESET corresponding to the scheduling DCI) to the reception operation of the PDSCH. Alternatively, the terminal may determine one of the unified TCI(s) applied to the period (e.g., slot) to which the PDSCH is allocated by the above-described method, and receive the PDSCH based on the determined TCI.

FIG. 10 is a conceptual diagram illustrating a second exemplary embodiment of a method for determining a TCI to be applied to a scheduled PDSCH.

Referring to FIG. 10, the terminal may receive scheduling information of repeated PDSCH transmission composed of first to fourth PDSCHs based on first DCI. The first to fourth PDSCHs may include the same TB or correspond to the same HARQ process. In addition, the base station may manage a beam of the terminal using the above-described unified TCI indication method. In this case, a first TCI set may be applied to a period (e.g., slot) to which the first PDSCH and the second PDSCH are allocated, and a second TCI set may be applied to a period (e.g., slot) to which the third PDSCH and fourth PDSCH are allocated. Each TCI set may include one or a plurality (e.g., two) unified TCIs for downlink reception.

Referring to the drawing, T_{offset,1}, which is a scheduling offset of the first PDSCH, may be smaller than the reference value or threshold. In this case, the terminal may receive the first PDSCH based on a default TCI. For example, the default TCI may be a TCI included in the first TCI set (e.g., the first-numbered TCI included in the first TCI set). In this case, several methods for the terminal to receive the remaining PDSCHs may be considered.

As a first method, the repeated PDSCH transmission may be configured to be received based on one TCI regardless of the number of indicated unified TCI(s). In this case, the terminal may apply a common TCI to all PDSCHs constituting the repeated transmission. In the above-described exemplary embodiment, the terminal may equally apply the default TCI used for reception of the first PDSCH to reception of the second, third, and fourth PDSCHs. Accordingly, an application time of the second TCI set may be delayed from an originally indicated application time (e.g., t1). For example, the application time point of the second TCI set may be changed to a time after a resource of the fourth PDSCH.

As a second method, the terminal may determine TCIs to be applied to the PDSCHs for respective TCI periods. For example, one TCI belonging to the first TCI set may be applied to the second PDSCH. In addition, one TCI belonging to the second TCI set may be applied to the third PDSCH and the fourth PDSCH. Scheduling offsets of the PDSCHs may be greater than or equal to the reference value. Whether to apply the default TCI according to the scheduling offset may be individually determined for each PDSCH (or each PDSCH instance). The one TCI may be a TCI separately indicated by the first DCI according to the method described above. As a similar method, a TCI may be determined for each TCI period, and the same TCI may be applied to all PDSCHs within each TCI period. Accordingly, the default TCI used in the reception operation of the first PDSCH may be equally applied to the reception operation of the second PDSCH. The TCIs for the third and fourth PDSCHs may be determined in the same manner as the above-described method.

On the other hand, the repeated PDSCH transmission may be configured to be received based on a plurality of TCIs (e.g., two TCIs or up to two TCIs). In the above-described exemplary embodiment, two unified TCIs may be applied to the reception operation of the four PDSCHs. For example, two TCIs may be applied to the PDSCHs in an interlaced manner (e.g., cross-mapping manner). The first TCI (or second TCI) may be applied to the first PDSCH and the third PDSCH, and the second TCI (or first TCI) may be applied to the second PDSCH and the fourth PDSCH. The first TCI and the second TCI may be unified TCIs indicated to a slot to which the first PDSCH, which is the first-numbered PDSCH, is allocated. In other words, the first TCI and the second TCI may be included in the first TCI set. For example, the first TCI and the second TCI may be the first-numbered TCI and the second-numbered TCI belonging to the first TCI set, respectively. The above-described TCI mapping rule may be predefined in technical specifications. Alternatively, the above-described TCI mapping rule may be configured to the terminal by the base station.

According to the TCI mapping rule, the default TCI may be applied to some PDSCHs. For example, the default TCI may be applied to PDSCH(s) having a scheduling offset smaller than the reference value. A method of applying a TCI determined by the mapping rule to PDSCH(s) having a scheduling offset not smaller than the reference value may be used. In the above-described exemplary embodiment, the scheduling offset of the first PDSCH may be smaller than the reference value, and the default TCI may be applied to the first PDSCH. The scheduling offsets of the remaining PDSCHs may be greater than or equal to the reference value, and the TCIs according to the above-described rule may be mapped to the remaining PDSCHs. Alternatively, the default TCI mapped to the first PDSCH may be mapped to other PDSCH(s) in the interlaced manner. For example, the default TCI may be applied to the first PDSCH and the third PDSCH, and the second TCI (or first TCI) may be applied to the second PDSCH and the fourth PDSCH. According to the above-described method, even when the default TCI is applied to some PDSCHs, the multi-TRP-based PDSCH transmission scheme may be maintained.

Even when the repeated PDSCH transmission is configured to be received based on a plurality of TCIs, the terminal may determine TCIs to be applied to the PDSCHs for the respective TCI periods. In the above-described exemplary embodiment, the first TCI set may be applied to the first PDSCH and the second PDSCH, and the second TCI set may be applied to the third PDSCH and the fourth PDSCH. For example, the first TCI and the second TCI may be respectively applied to the first PDSCH and the second PDSCH, and the third TCI and the fourth TCI may be respectively applied to the third PDSCH and the fourth PDSCH. The third TCI and the fourth TCI may be TCIs belonging to the second TCI set. For example, the third TCI and the fourth TCI may be the first-numbered TCI and the second-numbered TCI belonging to the second TCI set, respectively. Even in this case, the default TCI may be exceptionally applied to a PDSCH that satisfies a predetermined condition as in the above-described method. The above-described interlaced mapping rule between TCIs and PDSCHs may be applied within each TCI period.

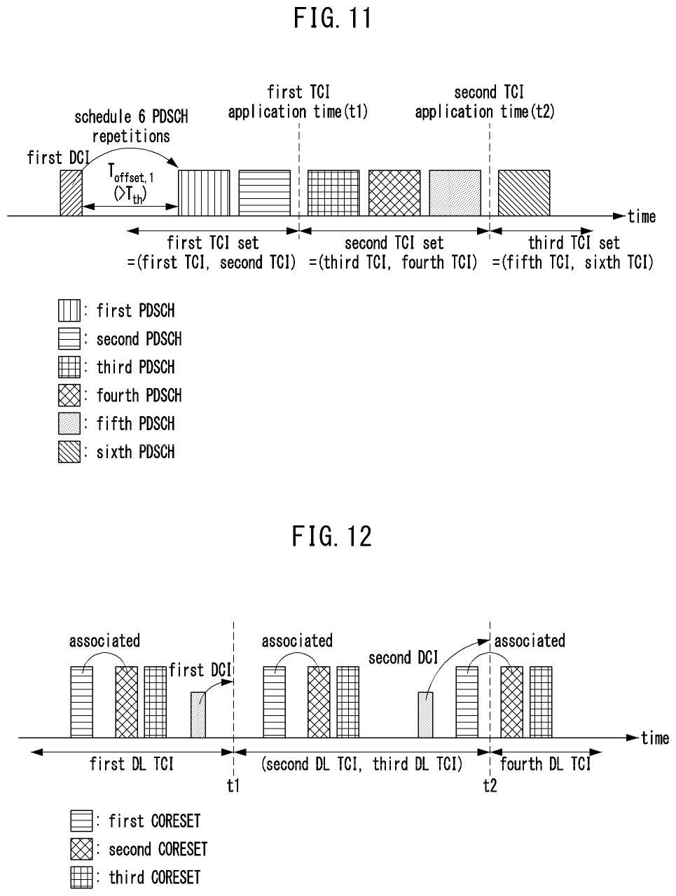

FIG. 11 is a conceptual diagram illustrating a third exemplary embodiment of a method for determining a TCI to be applied to a scheduled PDSCH.

Referring to FIG. 11, the terminal may receive scheduling information of repeated PDSCH transmission composed of first to sixth PDSCHs based on first DCI. In addition, the terminal may receive unified TCIs from the base station by the above-described method. A first TCI set including a first TCI and a second TCI may be indicated to a period to which the first and second PDSCHs are allocated, a second TCI set including a third TCI and a fourth TCI may be indicated to a period to which the third to fifth PDSCHs are allocated, and a third TCI set including a fifth TCI and a sixth TCI may be indicated to a period to which the sixth PDSCH is allocated. Each of the first TCI, the third TCI, and the fifth TCI may be the first-numbered TCI of each TCI set, and each of the second TCI, the fourth TCI, and the sixth TCI may be the second-numbered TCI of each TCI set. A TCI switching operation from the first TCI set to the second TCI set and a TCI switching operation from the second TCI set to the third TCI set may be indicated in the period to which the repeated PDSCH transmission is mapped. In other words, two TCI switching operations may be indicated to the terminal in the period to which the repeated PDSCH transmission is mapped.

Through the above-described method, unified TCI(s) indicated in the corresponding TCI period may be applied to each PDSCH. The first TCI and/or the second TCI may be applied to the first PDSCH and the second PDSCH belonging to the TCI period to which the first TCI set is indicated, the third TCI and/or the fourth TCI may be applied to the third to fifth PDSCHs belonging to the TCI period to which the second TCI set is indicated, and the fifth TCI and/or the sixth TCI may be applied to the sixth PDSCH belonging to the TCI period to which the third TCI set is indicated. Specifically, the first TCI, which is the first-numbered TCI of the first TCI set, may be applied to the first PDSCH, which is the first-numbered PDSCH of the TCI period to which the first TCI set is indicated, and the second TCI, which is the second-numbered TCI of the first TCI set, may be applied to the second PDSCH, which is a subsequent PDSCH in the corresponding TCI period, according to the TCI interlaced mapping rule. In addition, the third TCI, which is the first-numbered TCI of the second TCI set, may be applied to the third PDSCH, which is the first-numbered PDSCH of the TCI period to which the second TCI set is indicated, the fourth TCI, which is the second-numbered TCI of the second TCI set, may be applied to the fourth PDSCH, which is a subsequent PDSCH in the corresponding TCI period, and the third TCI, which is the first-numbered TCI of the second TCI set, may be applied to the fifth PDSCH, which is a subsequent PDSCH in the corresponding TCI period, according to the interlaced-mapping rule. Finally, the fifth TCI, which is the first-numbered TCI of the third TCI set, may be applied to the sixth PDSCH, which is the first-numbered PDSCH of the TCI period to which the third TCI set is indicated.

In the above-described exemplary embodiments, some of the PDSCHs constituting the repeated transmission may be dropped. In other words, the terminal may not receive some PDSCHs among the PDSCHs constituting the repeated transmission. Dropping of some of the PDSCHs may not affect TCI mapping to the remaining non-dropped PDSCH(s). A rule for mapping TCI(s) to the PDSCHs constituting the repeated transmission may be independent of whether some PDSCHs are dropped. In other words, TCI mapping for each PDSCH may be performed based on nominally scheduled PDSCHs rather than actually received PDSCHs.

In the present disclosure, the indicated TCI may mean one TCI among TCIs (or TCI pool) configured in the terminal or TCI(s) activated in the terminal. The TCI pool may mean a set of candidate TCIs, and may be divided into a downlink TCI pool and an uplink TCI pool, and the TCI pool (e.g., downlink TCI pool and uplink TCI pool) may be configured in the terminal. Alternatively, a joint downlink/uplink TCI pool (hereinafter referred to as ‘joint TCI pool’) may be configured in the terminal. The candidate TCIs belonging to the joint TCI pool may be applied to both downlink reception and uplink transmission. The TCI pool may be reconfigured by RRC signaling, and a set of activated TCI(s) may be changed by a MAC CE. Considering the above-described operation, the TCI indicated by the DCI may be one of valid TCIs or activated TCIs in the corresponding slot.

Meanwhile, transmission based on multiple TCIs may be configured or scheduled in a period to which a single unified TCI is indicated. For example, repeated PDSCH transmission may be scheduled in a period to which the first unified TCI is indicated, and the repeated PDSCH transmission may be configured to be received based on a plurality of TCIs. The repeated PDSCH transmission may correspond to a semi-persistently scheduled PDSCH (e.g., SPS PDSCH). In this case, the transmission (i.e., repeated PDSCH transmission) may be received based on the first unified TCI, which is a TCI indicated to the period in which the transmission is scheduled, rather than the plurality of TCIs. The same TCI (e.g., first unified TCI) may be applied to all transmission instances (e.g., all PDSCH instances) constituting the repeated transmission (e.g., repeated PDSCH transmission). Alternatively, even though the transmission is scheduled for a single TCI period, the transmission may be exceptionally received based on the plurality of TCIs configured for the transmission. Alternatively, the transmission may be received based on one TCI among the plurality of TCIs configured for the transmission.

(Method 200) may be generalized considering multi-TRP transmission. The two TCI sets may be indicated to the terminal by the same DCI (e.g., scheduling DCI). The two TCI sets may include a first TCI set and a second TCI set. The first TCI set may include unified TCI(s) indicated to the terminal. The second TCI set may include TCI(s) applied to a PDSCH, CSI-RS, PUSCH, PUCCH, SRS, etc. scheduled by the DCI. The numbers of TCI(s) included in the first TCI set and the second TCI set may be the same or different. The first TCI set and the second TCI set may be indicated by one DCI field. Alternatively, the first TCI set and the second TCI set may be indicated by different DCI fields.

The above-described method may increase the degree of freedom of TCI control, but may have a disadvantage of increasing the DCI payload size. As another method for reducing the DCI overhead, a plurality of TCI modes may be defined. For example, a first TCI mode may mean a mode in which a signal scheduled by the DCI is received (or transmitted) based on unified TCI(s) (e.g., first TCI set) indicated to a time period (e.g., slot (s)) to which the signal is allocated. A second TCI mode may mean a mode in which a signal scheduled by the DCI is received (or transmitted) based on TCI(s) (e.g., second TCI set) specifically indicated to the signal. The base station may select one of the plurality of TCI modes and may indicate the selected TCI mode to the terminal through the DCI. In other words, the DCI may include information (or a field) indicating the TCI mode. For another example, the first TCI mode may be a mode in which the terminal receives (or transmits) the scheduled signal based on a single TCI, and the second TCI mode may be a mode in which the terminal receives (or transmits) the scheduled signal based on multiple TCIs. For another example, the reception (or transmission) operations of the terminal, which respectively correspond to the first TCI mode and the second TCI mode, may be defined based on configuration information received from the base station. Here, ‘TCI mode’ may be a term of convenience for specifying operations related to different TCIs.

FIG. 12 is a conceptual diagram illustrating a first exemplary embodiment of a method of applying TCI(s) to a CORESET in a multi-unified TCI period.

Referring to FIG. 12, the terminal may receive unified TCI(s) through DCI. In other words, the DCI may indicate the unified TCI(s) to the terminal. In addition, the terminal may receive configuration information of a first CORESET, a second CORESET, and a third CORESET, and may perform PDCCH monitoring operations in the periodically repeated CORESETs. Each CORESET shown in the drawing may mean a search space set belonging to the CORESET or a PDCCH monitoring occasion corresponding to the CORESET.

The first CORESET and the second CORESET may be associated with each other for repeated PDCCH transmission. Specifically, a first search space set belonging to the first CORESET and a second search space set belonging to the second CORESET may be configured to be linked to each other, and PDCCH candidate(s) belonging to the first search space set and PDCCH candidate(s) belonging to the second search space set may be linked to each other according to a one-to-one correspondence relationship. A PDCCH may be repeatedly transmitted in the plurality of associated PDCCH candidates (e.g., a first PDCCH candidate belonging to the first search space set and a second PDCCH candidate belonging to the second search space set).

A resource of the first PDCCH candidate and a resource of the second PDCCH candidate, which are linked to each other, may belong to the same unified TCI period. For example, the unified TCI period may belong to a period to which a first downlink TCI is indicated (e.g., a period before t1). In this case, the terminal may monitor the first PDCCH candidate and the second PDCCH candidate based on the same unified TCI (e.g., the first downlink TCI). In other words, repeated PDCCH transmission may be transmitted from a single TRP based on a single TCI. The above-described operation may be performed regardless of the TCIs respectively configured in the first CORESET and the second CORESET. For another example, the resource of the first PDCCH candidate and the resource of the second PDCCH candidate, which are linked to each other, may belong to a period to which multiple unified TCIs (e.g., a second downlink TCI and a third downlink TCI) are indicated (i.e., a period between t1 and t2). In this case, the terminal may monitor each of the first PDCCH candidate and the second PDCCH candidate based on the same plurality of unified TCIs (e.g., ‘second downlink TCI and third downlink TCI’ or ‘third downlink TCI and second downlink TCI’). In other words, the repeated PDCCH transmission may be transmitted from two TRPs based on two TCIs. The above-described operation may also be performed regardless of the TCIs respectively configured in the first CORESET and the second CORESET.

The two TCIs may be respectively mapped to two PDCCH candidates constituting the repeated PDCCH transmission based on a predefined rule. The mapping may be determined based on IDs of CORESETs, search space sets, etc. corresponding to the PDCCH candidates. For example, among the indicated unified TCIs, the first-numbered TCI may be mapped to a PDCCH candidate corresponding to a CORESET, search space set, or the like having a low ID (or a high ID) among the two PDCCH candidates, and the second-numbered TCI may be mapped to the other PDCCH candidate. Alternatively, the mapping may be determined based on an arrangement order of time resources of the PDCCH candidates. For example, among the indicated unified TCIs, the first-numbered TCI may be mapped to a PDCCH candidate having an earlier (or not later) start symbol, and the second-numbered TCI may be mapped to the other PDCCH candidate. For another example, among the indicated unified TCIs, the first-numbered TCI may be mapped to a PDCCH candidate having an earlier (or not later) end symbol, and the second-numbered TCI may be mapped to the other PDCCH candidate.

Alternatively, the resource of the first PDCCH candidate and the resource of the second PDCCH candidate, which are linked to each other, may belong to different unified TCI periods. In the above-described exemplary embodiment, the first CORESET and the second CORESET, which are associated with each other, may respectively belong to a multi-unified TCI period before t2 and a single unified TCI period after t2. In this case, TCI(s) indicated to a TCI period to which each PDCCH candidate belongs may be applied to the each PDCCH candidate corresponding to each CORESET. In other words, the first PDCCH candidate may be monitored based on the second downlink TCI and/or the third downlink TCI, and the second PDCCH candidate may be monitored based on the fourth downlink TCI. Alternatively, the terminal may not expect PDCCH candidates linked to each other to belong to different unified TCI periods as in the above-described method. Alternatively, the terminal may not expect to receive a unified TCI indication that results in the above-described result.

In the above-described exemplary embodiment, the third CORESET may be a CORESET not involved in repeated PDCCH transmission. In this case, the indicated single unified TCI may be applied to the third CORESET belonging to the period to which the single unified TCI is indicated. On the other hand, one TCI (e.g., the second downlink TCI or the third downlink TCI) among the indicated multiple unified TCIs may be applied to the third CORESET belonging to the period to which the multiple unified TCIs are indicated (e.g., a period between t1 and t2). The one TCI may mean the above-described default TCI, and may be selected by the above-described operation of determining the default TCI. Alternatively, the one TCI may be selected based on an ID of the CORESET (or an ID of the search space set in which the monitoring operation is to be performed).

The proposed unified TCI indication method may be applied differently for each CORESET type. For example, a certain CORESET may include only a search space set for reception of a terminal-specific PDCCH (or unicast PDCCH) and/or a PDSCH (or unicast PDSCH) corresponding to the terminal-specific PDCCH (or unicast PDCCH). In other words, the certain CORESET may include only a USS set and/or a specific CSS set (e.g., Type 3 CSS set). The CORESET may be referred to as a first type CORESET. The terminal may monitor the first type CORESET and a search space set corresponding to the first type CORESET based on the indicated unified TCI. On the other hand, the certain CORESET may include only a search space set for reception of a common PDCCH (or broadcast or multicast PDCCH) and/or a PDSCH (or broadcast PDSCH, multicast PDSCH) corresponding to the common PDCCH. In other words, the certain CORESET may not include a USS set or a specific CSS set (e.g., Type 3 CSS set). The CORESET may include Type 0, 0A, 1, and/or 2 CSS set. The CORESET may be referred to as a second type CORESET. The terminal may not apply the indicated unified TCI to the second type CORESET, and monitor the second type CORESET and a search space set corresponding to the second type CORESET based on a TCI that is separately configured or indicated for the second type CORESET. In addition, the certain CORESET may include both a search space set corresponding to the first type CORESET and a search space set corresponding to the second type CORESET. For example, the certain CORESET may include a USS set and a Type 0 CSS set. The CORESET may be referred to as a third type CORESET. The base station may configure whether to apply the unified TCI to monitoring of the third type CORESET to the terminal through a signaling procedure. In this case, according to the configuration of the base station, the terminal may receive the third type CORESET based on the unified TCI or a separately configured TCI. The method applied to the third type CORESET may be equally applied to a CORESET having a CORESET ID 0 (e.g., CORESET 0).

Meanwhile, when a plurality of CORESET pools are configured in the terminal, the unified TCI may be indicated for each CORESET pool. For example, a first downlink TCI and a second downlink TCI may be indicated to the terminal by DCI, and the first downlink TCI and the second downlink TCI may be applied to a first CORESET pool and a second CORESET pool configured in the terminal, respectively. In the period to which the multiple unified TCIs are applied, the terminal may receive CORESET(s) belonging to the first CORESET pool based on the first downlink TCI, and may receive CORESET(s) belonging to the second CORESET pool based on the second downlink TCI. The times at which the multiple unified TCIs are applied to the CORESET pools may be determined to be the same or different from each other by the above-described method. The first CORESET pool and the second CORESET pool may correspond to a CORESET pool having ID=0 and a CORESET pool having ID=1, respectively.

Alternatively, the terminal may apply the unified TCI indicated by the DCI received from a CORESET belonging to the first CORESET pool to reception or transmission of a signal associated with the first CORESET pool. The signal associated with the first CORESET pool may include CORESETs belonging to the first CORESET pool, search space sets corresponding to the CORESETs, signals (e.g., PDSCH, PUSCH, PUCCH, CSI-RS, SRS) scheduled by PDCCHs transmitted in the search space sets, and the like. The unified TCI may not be applied to reception or transmission of the signal associated with the second CORESET pool. Similarly, the terminal may apply the unified TCI indicated by the DCI received from a CORESET belonging to the second CORESET pool to reception or transmission of a signal associated with the second CORESET pool. The unified TCI may not be applied to reception or transmission of a signal associated with the first CORESET pool.

A certain CORESET pool may include both a CORESET to which the unified TCI is applied and a CORESET to which the unified TCI is not applied (e.g., CORESET to which a TCI configured separately for the CORESET is applied). For example, the first CORESET pool may include the first type CORESET and the second type CORESET. For another example, the first CORESET pool may include the first type CORESET and the CORESET 0, and the CORESET 0 may be configured so that the unified TCI is not applied to the CORESET 0. In this case, different TCIs may be applied to a plurality of CORESETs constituting the first CORESET pool.

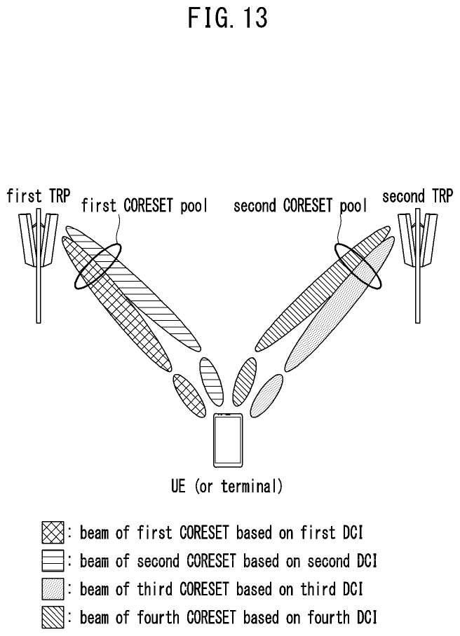

FIG. 13 is a conceptual diagram illustrating a first exemplary embodiment of a PDCCH monitoring method using a plurality of TCIs within a CORESET pool.

Referring to FIG. 13, the terminal may receive configuration information of a plurality of CORESET pools (e.g., a first CORESET pool and a second CORESET pool) from the base station. Each CORESET pool may correspond to each TRP. For example, the first CORESET pool and the second CORESET pool may correspond to a first TRP and a second TRP, respectively. The first CORESET pool may include a first CORESET and a second CORESET, and the second CORESET pool may include a third CORESET and a fourth CORESET.

Through the above-described method, the terminal may apply different TCIs to monitoring of a plurality of CORESETs constituting the same CORESET pool. Referring to FIG. 13, the terminal may apply a first TCI and a second TCI to monitoring of the first CORESET and the second CORESET, respectively. For example, the first TCI may be a unified TCI, and the first CORESET may be the first type CORESET. The second TCI may be a TCI separately configured for the second CORESET, and the second CORESET may be the second type CORESET. The terminal may apply a third TCI and a fourth TCI to monitoring of the third CORESET and the fourth CORESET, respectively. The third TCI may be a unified TCI, and the third CORESET may be the first type CORESET. The fourth TCI may be a TCI separately configured for the fourth CORESET, and the fourth CORESET may be the second type CORESET. In this case, a plurality of TCIs applied to CORESETs belonging to the same CORESET pool may correspond to the same physical cell ID (PCI). A QCL source signal of the first TCI and a QCL source signal of the second TCI may be transmitted from the same serving cell. In other words, a PCI of the source signal included in configuration information of the first TCI state may coincide with a PCI of the source signal included in configuration information of the second TCI state. According to the above constraint, PDCCHs transmitted from a plurality of serving cells may be monitored in different CORESET pools.

Meanwhile, as described above, the unified TCI may not be applied to a reception operation of a PDSCH. A TCI of the PDSCH may be indicated by DCI scheduling the PDSCH separately from the unified TCI. In this case, when a scheduling offset of the PDSCH is smaller than a reference value, the reception operation of the PDSCH may be performed based on a default TCI. The terminal may regard a TCI of a specific CORESET configured therein as the default TCI. For example, the terminal may regard a TCI of one CORESET (e.g., CORESET having a the lowest index or ID) among CORESET(s) mapped to the latest slot to which at least one CORESET is mapped as the TCI for reception of the PDSCH.

The above-described method may be modified in consideration of the CORESET type. For example, in the default TCI determination procedure, CORESETs to which the unified TCI is not applied (e.g., second type CORESET) and/or CORESETs configured not to apply the unified TCI may be considered. The terminal may first select CORESET(s) to which the unified TCI is not applied from among CORESET(s) mapped to the latest slot to which at least one CORESET is mapped, and regard a TCI of one CORESET (e.g., CORESET having the lowest index or ID) among the selected CORESET(s) as the TCI for reception of the PDSCH. For another example, in the default TCI determination procedure, CORESETs to which the unified TCI is applied (e.g., first-type CORESET) and/or CORESETs configured to apply the unified TCI may be considered. The terminal may first select CORESET(s) to which the unified TCI is applied from among CORESET(s) mapped to the latest slot to which at least one CORESET is mapped, and regard a TCI of one CORESET (e.g., CORESET having the lowest index or ID) among the selected CORESET(s) as the TCI for reception of the PDSCH. For another example, all types of CORESETs may be considered in the default TCI determination procedure. The terminal may regard a TCI of one CORESET (e.g., CORESET having the lowest index or ID) among all CORESET(s) mapped to the latest slot to which at least one CORESET is mapped as the TCI for reception of the PDSCH.

When a plurality of CORESET pools are configured in the terminal, the operation of determining the default TCI of the PDSCH may be performed for each CORESET pool. For example, in case of a PDSCH scheduled through the first CORESET pool, the terminal may select CORESET(s) to which the unified TCI is not applied among CORESET(s) which belong to the first CORESET pool and are mapped to the latest slot to which a CORESET belonging to the first CORESET pool is mapped, and regard a TCI of one CORESET (e.g., CORESET having the lowest index or ID) among the selected CORESET(s) as the TCI for reception of the PDSCH. Alternatively, the terminal may select CORESET(s) to which the unified TCI is applied from among CORESET(s) which belong to the first CORESET pool and are mapped to the latest slot to which a CORESET belonging to the first CORESET pool is mapped, and regard a TCI of one CORESET (e.g., CORESET having the lowest index or ID) among the selected CORESET(s) as the TCI for reception of the PDSCH. Alternatively, the terminal may regard a TCI of one CORESET (e.g., CORESET having the lowest index or ID) among all CORESET(s) which belong to the first CORESET pool and are mapped to the latest slot to which a CORESET belonging to the first CORESET pool is mapped as the TCI for reception of the PDSCH.

The terminal may use the default TCI determined by the above-described method not only as the TCI for reception of the PDSCH, but also as a TCI for reception of a CSI-RS or a TCI for transmission of a PUCCH, PUSCH, SRS, or the like.

On the other hand, when a quality of all beams of a downlink control channel or beams corresponding to the downlink control channel is deteriorated below a reference value, the terminal may determine a beam failure and initiate a beam recovery procedure. For the above-described operation, the base station may configure reference signal(s) for beam failure detection to the terminal by an explicit signaling method or an implicit signaling method. The reference signal for beam failure detection may be referred to as a beam failure detection (BFD)-RS, and a set of the BFD-RSs may be referred to as a set q0. In the case of the implicit signaling method, the terminal may regard QCL source signal(s) having QCL relationship(s) with CORESET(s) configured therein as BFD-RS(s), and the set q0 may include the QCL source signal(s).

When the unified TCI indication method is used, the CORESET type may be considered as a criterion for determining a beam failure by the terminal. When the BFD-RS set (e.g., q0) is determined by the implicit signaling method, the terminal may include only QCL source signal(s) of CORESET(s) having a specific type in the set q0, and may not include QCL source signal(s) of other CORESET(s) in the set q0. In other words, beams of the other CORESET(s) may be excluded from factors for determining a beam failure. For example, the set q0 may consist of only DM-RS(s) or QCL source signal(s) of CORESET(s) to which the unified TCI is not applied, and may not include DM-RS(s) or QCL source signal(s) of CORESET(s) to which the unified TCI is applied. The set q0 may include the first type CORESET and/or the CORESET configured not to apply the unified TCI, and may not include the second type CORESET or the CORESET configured to apply the unified TCI. For another example, the set q0 may consist of only DM-RS(s) or QCL source signal(s) of CORESET(s) to which the unified TCI is applied, and may not include DM-RS(s) or QCL source signal(s) of CORESET(s) to which the unified TCI is not applied. The set q0 may include the second type CORESET and/or the CORESET configured to apply the unified TCI, and may not include the first type CORESET or the CORESET configured not to apply the unified TCI. For another example, the set q0 may include DM-RS(s) or QCL source signal(s) of all CORESET(s) (i.e., all types of CORESET(s)).

When a plurality of CORESET pools are configured in the terminal, the above-described beam failure determination operation may be performed for each CORESET pool (e.g., for each TRP). For example, when attempting to determine a beam failure for the first CORESET pool (e.g., a TRP corresponding to the first CORESET pool), the terminal may include only DM-RS(s) or QCL source signal(s) of CORESET(s) to which the unified TCI is not applied among CORESETs belonging to the first CORESET pool, and may not include DM-RS(s) or QCL source signal(s) of the CORESET to which the unified TCI is applied in the set q0. Alternatively, in the above-described case, the terminal may include only DM-RS(s) or QCL source signal(s) of CORESET(s) to which the unified TCI is applied among the CORESETs belonging to the first CORESET pool in the set q0, and may not include DM-RS(s) or QCL source signal(s) of the CORESET to which the unified TCI is not applied in the set q0. Alternatively, in the above-described case, the terminal may include DM-RS(s) or QCL source signal(s) of all CORESET(s) belonging to the first CORESET pool in the set q0. When a beam quality (e.g., L1-RSRP, L1-SINR) of all signals included in the set q0 is less than or equal to a reference value, the terminal may determine a beam failure for the corresponding CORESET pool (e.g., the first CORESET pool, TRP corresponding to the first CORESET pool). The terminal may transmit information on a new beam candidate and/or information on the beam failure for the first CORESET pool to the base station through a signaling procedure (e.g., MAC CE), and perform a beam recovery request operation.

Generalizing the above-described operation, when the CORESET pool includes CORESETs corresponding to a plurality of TCIs, a transmission operation or reception operation of a signal by the terminal, which is associated with the CORESET pool, may be performed based on one TCI of the plurality of TCIs. In other words, a reception operation of a downlink signal (e.g., PDSCH, CSI-RS) scheduled by a CORESET belonging to the CORESET pool may be performed based on one TCI among the plurality of TCIs corresponding to the CORESET pool. In addition, a transmission operation of an uplink signal (e.g., PUSCH, PUCCH, SRS) scheduled by a CORESET belonging to the CORESET pool may be performed based on one TCI among the plurality of TCIs corresponding to the CORESET pool. The one TCI may be referred to as a representative TCI for convenience. An operation of selecting the representative TCI by the terminal may be performed based on a prioritization rule among the TCIs. For example, the unified TCI may have a higher priority than a TCI separately configured for a specific CORESET, and the unified TCI may be selected as the representative TCI according to the prioritization rule. Conversely, a TCI separately configured for a specific CORESET may have a higher priority than the unified TCI, and the TCI separately configured for a specific CORESET may be selected as the representative TCI according to the prioritization rule. Alternatively, the base station may inform the terminal of the representative TCI through a signaling procedure (e.g., RRC signaling, MAC CE, DCI). Information on the representative TCI may be included in configuration information of the CORESET pool. The representative TCI may also be referred to as a default TCI, a basic TCI, and the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, first unified transmission configuration indicator (TCI) information including a first TCI and a second TCI;
receiving, from the base station, first downlink control information (DCI) including first scheduling information of a first physical downlink shared channel (PDSCH) and information indicating at least one TCI among the first TCI and the second TCI belonging to the first unified TCI information; and
performing a first reception operation for the first PDSCH based on the at least one TCI and the first scheduling information.

2. The method according to claim 1, wherein the first DCI further includes second unified TCI information including a third TCI and a fourth TCI.

3. The method according to claim 2, wherein the at least one TCI and the second unified TCI information are indicated by one field or different fields within the first DCI, and the first DCI further includes information indicating an application time of the second unified TCI information.

4. The method according to claim 2, further comprising:
receiving, from the base station, second DCI including second scheduling information of a second PDSCH and information indicating one or more TCIs among the third TCI and the fourth TCI belonging to the second unified TCI information; and
performing a second reception operation for the second PDSCH based on the one or more TCIs and the second scheduling information.

5. The method according to claim 4, wherein the first PDSCH is scheduled within a first period to which the first unified TCI information is applied, and the second PDSCH is scheduled within a second period to which the second unified TCI information is applied.

6. The method according to claim 1, further comprising: receiving, from the base station, information indicating to perform a reception operation for downlink (DL) data based on a single TCI, wherein the first reception operation is performed based on one of the first TCI and the second TCI.

7. The method according to claim 1, wherein when performing of a reception operation for DL data based on multiple TCIs is not configured to the terminal, the first reception operation is performed based on one of the first TCI and the second TCI.

8. A method of a terminal, comprising:
receiving, from a base station, first unified transmission configuration indicator (TCI) information including a first TCI and a second TCI;
receiving, from the base station, first downlink control information (DCI) including first scheduling information of a first physical downlink shared channel (PDSCH);
selecting one TCI among the first TCI and the second TCI based on a predefined rule; and
performing a first reception operation for the first PDSCH based on the one TCI belonging to the first unified TCI information and the first scheduling information.

9. The method according to claim 8, wherein the predefined rule is to select a first-numbered TCI, a TCI with a lowest index, or a TCI with a highest index from among the first TCI and the second TCI belonging to the first unified TCI information.

10. The method according to claim 8, wherein the predefined rule is to select a default TCI among the first TCI and the second TCI belonging to the first unified TCI information when a scheduling offset between the first DCI and the first PDSCH is less than or equal to a reference value.

11. The method according to claim 8, wherein when information indicating to perform a reception operation for downlink (DL) data based on a single TCI is received from the base station or when performing of the reception operation for the DL data based on multiple TCIs is not configured to the terminal, the first reception operation is performed based on the one TCI among the first TCI and the second TCI.

12. The method according to claim 8, wherein the first DCI further includes second unified TCI information including a third TCI and a fourth TCI.

13. The method according to claim 12, further comprising:
receiving, from the base station, second DCI including second scheduling information of a second PDSCH;
selecting one TCI among the third TCI and the fourth TCI belonging to the second unified TCI information indicated by the first DCI; and
performing a second reception operation for the second PDSCH based on the one TCI belonging to the second unified TCI information and the second scheduling information.

14. A method of a base station, comprising:
transmitting, to a terminal, first unified transmission configuration indicator (TCI) information including a first TCI and a second TCI;
transmitting, to the terminal, first downlink control information (DCI) including first scheduling information of a first physical downlink shared channel (PDSCH) and information indicating at least one TCI among the first TCI and the second TCI belonging to the first unified TCI information; and
transmitting, to the terminal, the first PDSCH based on the at least one TCI and the first scheduling information.

15. The method according to claim 14, wherein the first DCI further includes second unified TCI information including a third TCI and a fourth TCI.

16. The method according to claim 15, wherein the at least one TCI and the second unified TCI information are indicated by one field or different fields within the first DCI, and the first DCI further includes information indicating an application time of the second unified TCI information.

17. The method according to claim 15, further comprising:
transmitting, to the terminal, second DCI including second scheduling information of a second PDSCH and information indicating one or more TCIs among the third TCI and the fourth TCI belonging to the second unified TCI information; and
transmitting, to the terminal, the second PDSCH based on the one or more TCIs and the second scheduling information.

18. The method according to claim 17, wherein the first PDSCH is scheduled within a first period to which the first unified TCI information is applied, and the second PDSCH is scheduled within a second period to which the second unified TCI information is applied.

19. The method according to claim 14, further comprising: transmitting, to the terminal, information indicating to perform a reception operation for downlink (DL) data based on a single TCI, wherein the first PDSCH is transmitted based on one of the first TCI and the second TCI.

20. The method according to claim 14, wherein when performing of a reception operation for DL data based on multiple TCIs is not configured to the terminal, the first PDSCH is transmitted based on one of the first TCI and the second TCI.
